(19) United States
(12) Patent Application Publication
(10) Pub. No.: US 2016/0187724 A1
(43) Pub. Date: Jun. 30, 2016

(54) IMAGE DISPLAY DEVICE

(71) Applicant: SHARP KABUSHIKI KAISHA, Osaka (JP)

(72) Inventors: Junichi MASUDA, Osaka-shi (JP); Kenta FUKUOKA, Osaka-shi (JP)

(21) Appl. No.: 14/910,751

(22) PCT Filed: Sep. 8, 2014
(86) PCT No.: PCT/JP2014/073626

§ 371 Date: Feb. 8, 2016

(30) Foreign Application Priority Data
Oct. 8, 2013 (JP) 2013-210912

(51) Int. Cl. G02F 1/1335; F21V 8/00

(52) U.S. Cl. CPC G02F 1/133536; G02B 6/0056; G02F 1/133514; G02B 6/0063

(57) ABSTRACT

In a see-through image display device, a first reflective polarizing plate and a second reflective polarizing plate are arranged with a light guiding plate positioned therebetween. Therefore, p-polarized light emitted by the light guiding plate toward the display screen side is reutilized by the first reflective polarizing plate causing the light to return to the light guiding plate, and further, p-polarized light emitted toward the back side is reutilized as well by the second reflective polarizing plate causing the light to return to the light guiding plate. In this manner, the light emitted by the light guiding plate toward the back side is also reused.

### TECHNICAL FIELD

The present invention relates to image display devices, particularly to a see-through image display device, which allows the background to be seen therethrough.

### BACKGROUND ART

Recent years have seen active development of see-through image display devices provided with displays which not only display images but also allow objects situated on the back side to be seen therethrough from the display screen side (also referred to below as “transparent displays”).

For example, Patent Document 1 describes the configuration of a display used in a conventional see-through image display device. FIG. 21 is a diagram illustrating the configuration of the display 60 used in the see-through image display device described in Patent Document 1. As shown in FIG. 21, the display 60 includes a diffractive optical element 66, a retardation film 65, a liquid crystal panel 64, a diffractive optical element 63, a polarization conversion film 62, and a light guiding plate 61 with a light source 67 attached at one end, which are arranged in this order from the display screen side toward the back side.

FIG. 22 is a diagram illustrating light transmission and absorption in the display 60. The liquid crystal panel 64 includes pixels 64a and 64b; the pixel 64a is shown as being in on-state by receiving a signal voltage applied in accordance with an image signal whereas the pixel 64b is shown as being in off-state and having no signal voltage applied thereto. The light source (not shown) attached at the end of the light guiding plate 61 is a fluorescent lamp or suchlike. The light guiding plate 61 irradiates the display screen side and the back side using light given out by the light source as backlight, as shown in FIG. 22. The polarization conversion film 62, which is disposed between the light guiding plate 61 and the liquid crystal panel 64, is a film which transmits s-polarized light included in the backlight and reflects p-polarized light included in the backlight. The reflected p-polarized light returns to the light guiding plate 61, and is emitted again as elliptically polarized light transformed from linearly polarized light. Once the elliptically polarized light emitted by the light guiding plate 61 is incident on the polarization conversion film 62 again, s-polarized light included in the elliptically polarized light is transmitted through the polarization conversion film 62. In this manner, along with the s-polarized light emitted by the light guiding plate 61, the s-polarized light converted from the p-polarized light by experiencing multiple reflection between the polarization conversion film 62 and the light guiding plate 61 is transmitted through the polarization conversion film 62.

The s-polarized light having been transmitted through the polarization conversion film 62 is then transmitted through the diffractive optical element 63 and is incident on each pixel of the liquid crystal panel 64. The s-polarized light is transmitted through the pixel 64a in on-state without being subjected to polarization conversion but transmitted through the pixel 64b in off-state as p-polarized light converted therefrom. The p-polarized light and the s-polarized light having been transmitted through the liquid crystal panel 64 are transmitted through the retardation film 65 and are incident on the diffractive optical element 66. The diffractive optical element 66 allows the s-polarized light to travel straight without diffraction but diffracts the p-polarized light diagonally upward in the figure. Accordingly, the viewer on the display screen side can visually recognize only the s-polarized light.

In the display 60 as above, along with the s-polarized light emitted by the light guiding plate 61, the s-polarized light converted from the p-polarized light by experiencing multiple reflection between the polarization conversion film 62 and the light guiding plate 61 is utilized as well, resulting in enhanced use efficiency of light. Moreover, the display 60 also functions as a transparent display capable of transmitting light incident from the back side therethrough to the display screen side, and therefore, the viewer on the display screen side can see any object and a background scene behind the display 60 through the on-state pixels 64a of the liquid crystal panel 64.

### CITATION LIST

### Patent Document

Patent Document 1: Japanese Patent Laid-Open Publication No. 2001-83458

### SUMMARY OF THE INVENTION

### Problems to be Solved by the Invention

The see-through image display device provided with the display 60 described in Patent Document 1 enhances use efficiency of backlight by causing the p-polarized light included in the backlight emitted by the light guiding plate 61 toward the display screen side to experience multiple reflection between the polarization conversion film 62 and the light guiding plate 61 and thereby converting the p-polarized light into the s-polarized light. However, this image display device uses none of the backlight emitted by the light guiding plate 61 toward the back side.

Therefore, an objective of the present invention is to provide a see-through image display device capable of further enhancing use efficiency of light emitted by a light guiding plate by efficiently utilizing not only light emitted by the light guiding plate toward the display screen side but also light emitted by the light guiding plate toward the back side.

### Means for Solving the Problems

A first aspect of the present invention is directed to an image display device comprising a display providing image display based on an image signal or functioning as a transparent display, wherein,

the display includes:

a light source configured to emit light including first polarized light and second polarized light;

a light guiding plate configured to emit light from the light source toward both a display screen side and a back side of the display, the light guiding plate having the light source attached at an end;

a first reflective polarizing plate and a second reflective polarizing plate being arranged with the light guiding plate positioned therebetween, such that the first reflective polarizing plate is disposed on the back side and the second reflective polarizing plate is disposed on the display screen side, a first liquid crystal panel capable of displaying an image based on an externally provided first image signal, the first liquid crystal panel including a plurality of pixels and being located on the display screen side relative to the second reflective polarizing plate, and

a first absorptive polarizing plate and a second absorptive polarizing plate being arranged with the first liquid crystal panel positioned therebetween, such that the first absorptive polarizing plate is disposed on the back side and the second absorptive polarizing plate is disposed on the display screen side,

the first reflective polarizing plate and the second reflective polarizing plate are first-phase polarizing plates configured to transmit the first polarized light therethrough.

the first absorptive polarizing plate is the first-phase polarizing plate,

the second absorptive polarizing plate is a second-phase polarizing plate configured to transmit the second polarized light therethrough,

when the first image signal is being provided to the first liquid crystal panel, screen portions that correspond to non-polarization conversion pixels of the first liquid crystal panel are in a first display state, and screen portions that correspond to polarization conversion pixels are in a second display state, so that an image based on the first image signal is displayed, and

when the first image signal is not being provided to the first liquid crystal panel, the pixels of the first liquid crystal panel are polarization conversion pixels, so that light incident from the back side reaches the display screen side.

According to a second aspect of the present invention, in the first aspect of the present invention, wherein,

the display further includes a third absorptive polarizing plate disposed on the back side relative to the first reflective polarizing plate, and

the third absorptive polarizing plate is the first-phase polarizing plate.

According to a third aspect of the present invention, in the first aspect of the present invention,

when a signal to change the polarization of the first polarized light to predetermined polarization between the first polarized light and the second polarized light is provided, the polarization conversion pixel of the first liquid crystal panel emits light obtained by converting the polarization of the first polarized light into the predetermined polarization.

According to a fourth aspect of the present invention, in the first aspect of the present invention, the first liquid crystal panel is a normally white liquid crystal panel.

According to a fifth aspect of the present invention, in the second aspect of the present invention, the first liquid crystal panel has a color filter attached to a surface.

According to a sixth aspect of the present invention, in the second aspect of the present invention, wherein,

the display further includes:

a second liquid crystal panel capable of displaying an image based on an externally provided second image signal, the second liquid crystal panel including a plurality of pixels and being located on the back side relative to the first reflective polarizing plate; and

a third absorptive polarizing plate and a fourth absorptive polarizing plate being arranged with the second liquid crystal panel positioned therebetween, such that the third absorptive polarizing plate is disposed on the back side relative to the second liquid crystal panel and the fourth absorptive polarizing plate is disposed on the display screen side relative to the second liquid crystal panel,

the third absorptive polarizing plate is the second-phase polarizing plate, and the fourth absorptive polarized plate is the first-phase polarizing plates, and when the second image signal is being provided to the second liquid crystal panel, screen portions that correspond to non-polarization conversion pixels of the second liquid crystal panel are in the first display state, and screen portions that correspond to polarization conversion pixels are in the second display state, so that an image based on the second image signal is displayed.

According to a seventh aspect of the present invention, in the first aspect of the present invention, wherein,

the display further includes:

a second liquid crystal panel capable of displaying an image based on an externally provided second image signal, the second liquid crystal panel including a plurality of pixels and being located on the back side relative to the first reflective polarizing plate; and

a third reflective polarizing plate located on the back side relative to the second liquid crystal panel,

the third reflective polarizing plate is the first-phase polarizing plate,

when the second image signal is being provided to the second liquid crystal panel, screen portions that correspond to non-polarization conversion pixels of the second liquid crystal panel are in the second display state, and screen portions that correspond to polarization conversion pixels are in the first display state, so that an image based on the second image signal is displayed, and

when the pixels of the second liquid crystal panel are non-polarization conversion pixels and the pixels of the first liquid crystal panel are polarization conversion pixels, light incident from the back side is transmitted sequentially through the pixels of the second liquid crystal panel and the pixels of the first liquid crystal panel and reaches the display screen side.

According to an eighth aspect of the present invention, in the sixth aspect of the present invention, when a signal to change the polarization of the first polarized light to predetermined polarization between the first polarized light and the second polarized light is provided, the polarization conversion pixel of the second liquid crystal panel emits light obtained by converting the polarization of the first polarized light into the predetermined polarization.

According to a ninth aspect of the present invention, in the sixth aspect of the present invention, the second liquid crystal panel is a normally white liquid crystal panel.

According to a tenth aspect of the present invention, in the first aspect of the present invention, the light source emits light sequentially in a plurality of colors in a time division manner.

According to an eleventh aspect of the present invention, in the first aspect of the present invention, the light guiding plate has a degree of haze adjusted to from 2% to 3%.

According to a twelfth aspect of the present invention, in the eleventh aspect of the present invention, the degree of haze of the light guiding plate is adjusted by incorporating transparent particles about the size of from 20 μm to 300 μm in the light guiding plate at the time of production.

### Effect of the Invention

In the first invention, the first reflective polarizing plate and the second reflective polarizing plate are arranged with the light guiding plate being positioned therebetween. Therefore, the second polarized light emitted by the light guiding plate toward the display screen side is reutilized by the first reflective polarizing plate causing the light to return to the light guiding plate, and further, the second polarized light emitted toward the back side is reutilized as well by the second reflective polarizing plate causing the light to return to the light guiding plate. In this manner, the light emitted by the light guiding plate is utilized, resulting in enhanced use efficiency of the light emitted by the light guiding plate. Moreover, the non-polarization conversion pixels are in the first display state. On the other hand, the polarization conversion pixels convert the first polarized light incident thereon into second polarized light. The second polarized light is transmitted through the second absorptive polarizing plate, so that screen portions that correspond to the polarization conversion pixels are in the second display state. Consequently, the viewer on the display screen side can visually recognize a monochrome image based on the first image signal. On the other hand, in the case where all pixels of the first liquid crystal panel are polarization conversion pixels, light from the back side of the display passes through the polarization conversion pixels to the display screen side, and therefore, the viewer on the display screen side can visually recognize the back side from the display screen side through the first liquid crystal panel.

In the second invention, the display configuration from the light guiding plate to the second absorptive polarizing plate is the same as in the second invention, and therefore, the viewer on the display screen side can visually recognize a monochrome image based on the first image signal. On the other hand, when all pixels of the first liquid crystal panel are polarization conversion pixels, light incident from the back side of the display is transmitted to the display screen side, and therefore, the viewer on the display screen side can visually recognize the state of the back side from the display screen side through the first liquid crystal panel. At the same time, light incident from the display screen side of the display is transmitted to the back side, and therefore, the viewer on the back side can visually recognize the state of the display screen side from the back side through the first liquid crystal panel.

In the third invention, the polarization conversion pixel of the first liquid crystal panel emits light obtained by converting the polarization of the first polarized light into predetermined polarization between the first polarized light and the second polarized light, so that the first liquid crystal panel displays an image in gradations.

In the fourth invention, to cause pixels of the normally white first liquid crystal panel to become polarization conversion pixels and thereby bring their corresponding screen portions into the second display state, it is simply required to bring the pixels into off-state, and therefore, the fifth invention renders it possible to facilitate control of the first liquid crystal panel.

The fourth invention allows the viewer on the display screen side to visually recognize a color image based on the first image signal, and also renders it possible to display a color image of the state of the back side through the first liquid crystal panel.

In the sixth invention, Both the display configuration from the first reflective polarizing plate to the second absorptive polarizing plate on the display screen side and the configuration from the second reflective polarizing plate to the third absorptive polarizing plate on the back side are the same as the configuration of the display incorporated in the second invention. Accordingly, the viewer on the display screen side can visually recognize a monochrome image based on the first image signal, whereas the viewer on the back side can visually recognize a monochrome image based on the second image signal. Moreover, light emitted toward the display screen side by the light guiding plate and light emitted toward the back side are respectively utilized as light to be transmitted through the first liquid crystal panel and light to be transmitted through the second liquid crystal panel, resulting in further enhanced use efficiency of the light emitted by the light guiding plate.

In the seventh invention, the display configuration from the light guiding plate to the second absorptive polarizing plate is the same as the configuration of the display incorporated in the second invention. Accordingly, the viewer on the display screen side can visually recognize a monochrome image based on the first image signal. Moreover, first polarized light included in light emitted toward the back side by the light guiding plate is transmitted through the second liquid crystal panel being provided with the second image signal and also through the third reflective polarizing plate, and reaches the back side. In this case, the third reflective polarizing plate reflects light incident from the back side and therefore becomes specular. Therefore, the viewer on the back side can visually recognize an image based on the second image signal displayed on the mirror-like surface reflecting the background. On the other hand, when the pixels of the first liquid crystal panel are polarization conversion pixels, and the pixels of the second liquid crystal panel are non-polarization conversion pixels, first polarized light incident from the back side is transmitted sequentially through the non-polarization conversion pixels of the second liquid crystal panel and the polarization conversion pixels of the first liquid crystal panel, and reaches the display screen side. Thus, the viewer on the display screen side can visually recognize the state of the back side from the display screen side through both the first and second liquid crystal panels.

In the eighth invention, the polarization conversion pixel of the second liquid crystal panel emits light obtained by converting the polarization of the first polarized light into the predetermined polarization, so that the second liquid crystal panel displays an image in gradations.

In the eleventh invention, to cause pixels of the normally white second liquid crystal panel to become polarization conversion pixels and thereby bring their corresponding screen portions into the second display state, it is simply required to bring the pixels into off-state, and therefore, the tenth invention renders it possible to facilitate which facilitates control of the second liquid crystal panel.

In the tenth invention, the color of light emitted by the light source is changed in a time division manner, so that the viewer on the display screen side can visually recognize a color image based on the first image signal and can also visually recognize a color image of the state of the back side through the first liquid crystal panel, whereas the viewer on the back side can visually recognize a color image based on the second image signal and can also visually recognize a color image of the state of the display screen side through the second liquid crystal panel, and further, these images can be displayed with a higher intensity when compared to the case where a color filter is used.

In the eleventh invention, the degree of haze of the light guiding plate is adjusted to allow the light guiding plate to readily cause diffuse reflection. Accordingly, the light guiding plate readily generates first polarized light and second polarized light from second polarized light reflected by either the first or second reflective polarizing plate. Thus, it is rendered possible to enhance use efficiency of the light emitted by the light guiding plate.

In the twelfth invention, the display uses the light guiding plate with transparent particles about the size of from 20 μm to 300 μm incorporated therein at the time of production, and therefore can display a higher quality image compared to displays using light guiding plates produced by other methods.

### BRIEF DESCRIPTION OF THE DRAWINGS

FIG. 1 is a diagram illustrating the configuration of a display used for the basic study.

FIG. 2 is a diagram illustrating light transmission and absorption in the display shown in FIG. 1 where a liquid crystal panel is being provided with an image signal.

FIG. 3 is a diagram illustrating light transmission and absorption in the display shown in FIG. 1 where all pixels of the liquid crystal panel are in off-state.

FIG. 4 is a block diagram illustrating the configuration of an image display device including the display shown in FIG. 1.

FIG. 5 is a diagram illustrating the configuration of a display used in a see-through image display device according to a first embodiment of the present invention.

FIG. 6 is a diagram illustrating light transmission and absorption in the display shown in FIG. 5 where a liquid crystal panel is being provided with an image signal.

FIG. 7 is a diagram illustrating light transmission and absorption in the display shown in FIG. 5 where all pixels of the liquid crystal panel are in off-state.

FIG. 8 provides cross-sectional views of light guiding plates adapted to cause diffuse reflection; more specifically, part (A) is a cross-sectional view of a haze-controlled light guiding plate, part (B) is a cross-sectional view of a light guiding plate with dots printed on opposite surfaces, and part (C) is a cross-sectional view of a light guiding plate with wedges provided on opposite surfaces.

FIG. 9 is a diagram illustrating the configuration of a display used in a see-through image display device according to a second embodiment of the present invention.

FIG. 10 is a diagram illustrating light transmission and absorption in the display shown in FIG. 5 where a liquid crystal panel in the display is being provided with an image signal.

FIG. 11 is a diagram illustrating transmission and absorption of light from an object situated on the back side of the display shown in FIG. 5 where all pixels of the liquid crystal panel are in off-state.

FIG. 12 is a diagram illustrating transmission and absorption of light from an object situated on the display screen side of the display shown in FIG. 5 where all pixels of the liquid crystal panel are in off-state.

FIG. 13 is a diagram illustrating the configuration of a display used in a see-through image display device according to a third embodiment of the present invention.

FIG. 14 is a diagram illustrating light transmission and absorption in the display shown in FIG. 13 where first and second liquid crystal panels are being provided with first and second image signals, respectively.

FIG. 15 is a diagram illustrating the configuration of a display used in a see-through image display device according to a fourth embodiment of the present invention.

FIG. 16 is a diagram illustrating light transmission and absorption in the display shown in FIG. 15 where first and second liquid crystal panels are being provided with image signals.

FIG. 17 is a diagram illustrating transmission and absorption of light from an object situated on the back side of the display shown in FIG. 15 where all pixels of the first liquid crystal panel are in off-state, and all pixels of the second liquid crystal panel are in on-state.

FIG. 18 is a diagram illustrating the configuration of a display which is a first variant of the display shown in FIG. 5.

FIG. 19 is a diagram illustrating light transmission and absorption in the display in the first embodiment shown in FIG. 5 where gradation display is provided in accordance with an image signal provided to the liquid crystal panel.

FIG. 20 is a diagram illustrating light absorption and transmission where the display in the first embodiment shown in FIG. 5 uses a normally black liquid crystal panel.

FIG. 21 is a diagram illustrating the configuration of a display used in a see-through image display device described in Patent Document 1.

FIG. 22 is a diagram illustrating light transmission and absorption in the display shown in FIG. 21.

### MODES FOR CARRYING OUT THE INVENTION

<1. Basic Study>

The basic study preliminarily carried out by the present inventor in order to solve the above problem will be described first before providing the description of image display devices according to embodiments of the present invention.

<1.1 Display Configuration>

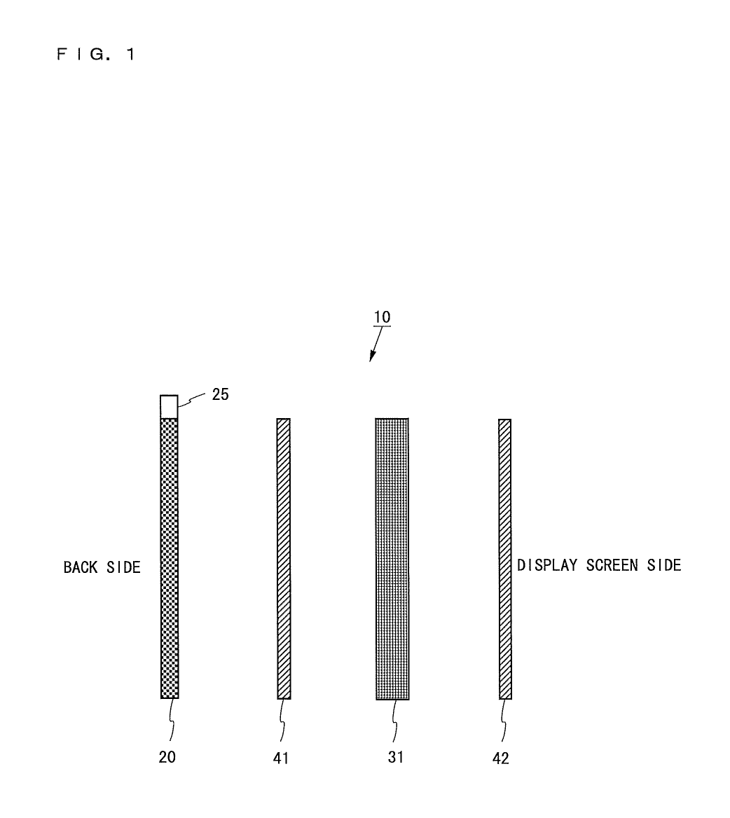

FIG. 1 is a diagram illustrating the configuration of a display 10 used for the basic study. The display 10 includes a second absorptive polarizing plate 42, a normally white liquid crystal panel 31, a first absorptive polarizing plate 41, and a light guiding plate 20, which are arranged in this order from the display screen side to the back side, as shown in FIG. 1.

Since the liquid crystal panel 31 is a normally white panel, pixels included in the liquid crystal panel 31 become transparent in off-state (where no signal voltage or a 0V signal voltage is being written), and also become black with light transmittance decreasing as the signal voltage being written rises. The first absorptive polarizing plate 41 is attached to the surface of the liquid crystal panel 31 on the back side, and the second absorptive polarizing plate 42, which is in opposite phase to the first absorptive polarizing plate 41, is attached to the surface of the liquid crystal panel 31 on the display screen side. Specifically, the first absorptive polarizing plate 41 is a polarizing plate which transmits p-polarized light therethrough and absorbs s-polarized light, and in contrast, the second absorptive polarizing plate 42 is a polarizing plate which transmits s-polarized light therethrough and absorbs p-polarized light. Herein, one of either p-polarized light or s-polarized light will also be referred to as first polarized light and the other will also be referred to as second polarized light. Moreover, the polarizing plate that transmits the first polarized light therethrough and absorbs the second polarized light will also be referred to as the “first-phase polarizing plate”, and in contrast, the polarizing plate that transmits the second polarized light therethrough and absorbs the first polarized light will also be referred to as the “second-phase polarizing plate”.

Furthermore, the light guiding plate 20 disposed on the back side relative to the first absorptive polarizing plate 41 is made with a transparent resin such as acrylic or polycarbonate, and has a light source 25, such as an LED (light-emitting diode) device, attached at one end. Accordingly, light emitted by the light source 25, including p-polarized light and s-polarized light, propagates through the light guiding plate 20 while experiencing total reflection, and exits the display screen-side surface and the back-side surface of the light guiding plate 20 toward the display screen side and the back side of the display 10.

<1.2 Light Transmission and Absorption where the Liquid Crystal Panel is being Provided with an Image Signal>

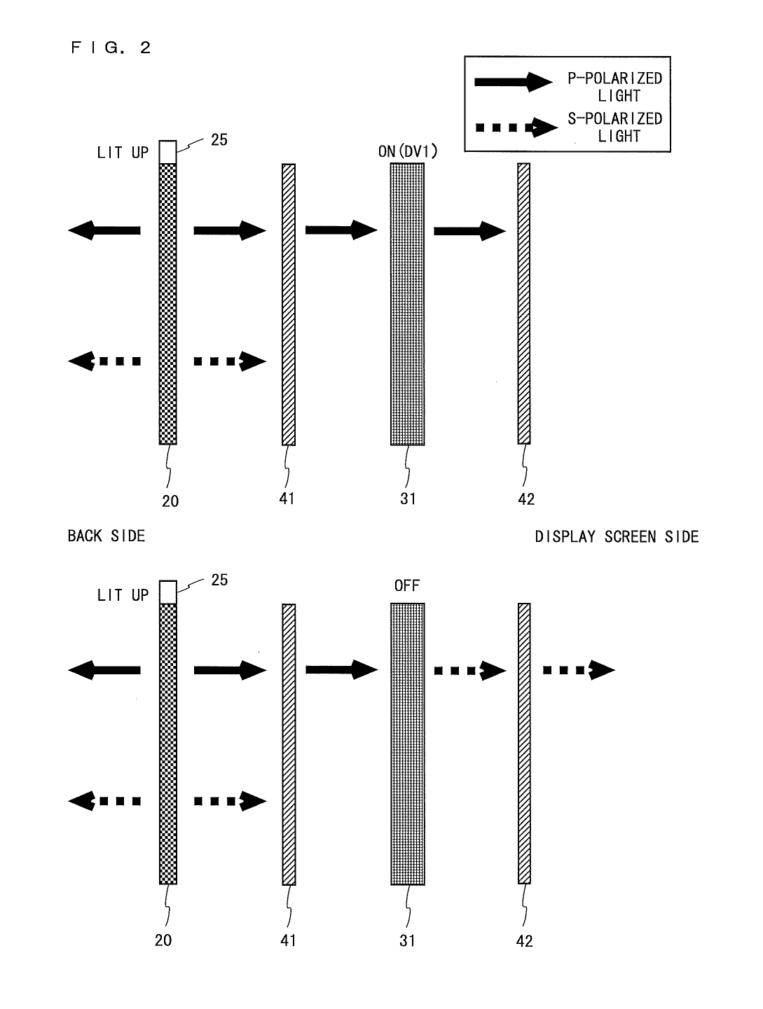

FIG. 2 is a diagram illustrating light transmission and absorption in the display 10 used for the basic study where the liquid crystal panel 31 is being provided with an image signal DV1; more specifically, the upper panel of FIG. 2 provides an illustration of light transmission and absorption where the pixels of the liquid crystal panel 31 are in on-state, and the lower panel of FIG. 2 provides an illustration of light transmission and absorption where the pixels of the liquid crystal panel 31 are in off-state. Herein, any pixel to which a signal voltage in accordance with the image signal DV1 has been written will be referred to as an on-state pixel, and a pixel to which a 0V voltage has been written will be referred to as an off-state pixel.

First, transmission and absorption of p-polarized light and s-polarized light by the on-state pixels will be described with reference to the upper panel of FIG. 2. When the light source 25 is lit up, p-polarized light and s-polarized light are emitted by the light guiding plate 20 and are incident on the first absorptive polarizing plate 41, so that the s-polarized light is absorbed by the first absorptive polarizing plate 41, and the p-polarized light is transmitted through the first absorptive polarizing plate 41 and is incident on the liquid crystal panel 31. The on-state pixels of the liquid crystal panel 31 allows the incident p-polarized light to pass therethrough without changing the polarization of the light, so that the light is emitted toward the second absorptive polarizing plate 42. Since the second absorptive polarizing plate 42 absorbs p-polarized light, the p-polarized light incident on the second absorptive polarizing plate 42 is absorbed by the second absorptive polarizing plate 42. In this case, neither the p-polarized light nor the s-polarized light emitted by the light guiding plate 20 reaches the front screen side, and therefore, screen portions that correspond to the on-state pixels are displayed in black.

Next, transmission and absorption of p-polarized light and s-polarized light by the off-state pixels will be described with reference to the lower panel of FIG. 2. Here, light is emitted by the light guiding plate 20, but the pixels of the liquid crystal panel 31 are in off-state. As in the case of the upper panel of FIG. 2, p-polarized light included in the light emitted by the light guiding plate 20 is incident on the off-state pixels of the liquid crystal panel 31. The off-state pixels convert the incident p-polarized light into s-polarized light, and emit the s-polarized light toward the second absorptive polarizing plate 42. Since the second absorptive polarizing plate 42 transmits s-polarized light therethrough, the s-polarized light incident on the second absorptive polarizing plate 42 is transmitted through the second absorptive polarizing plate 42. As a result, the p-polarized light emitted by the light guiding plate 20 reaches the front screen side after being converted into the s-polarized light, and therefore, screen portions that correspond to the off-state pixels are displayed in white.

In this manner, the image signal DV1 is provided to each pixel of the liquid crystal panel 31, so that screen portions that correspond to the on-state pixels of the liquid crystal panel 31 are displayed in black whereas screen portions that correspond to the off-state pixels are displayed in white. Consequently, the liquid crystal panel 31 displays a monochrome (black and white) image consisting of the screen portions displayed in black and the screen portions displayed in white. Therefore, the viewer on the display screen side can see the monochrome image based on the image signal DV1.

As described above, in the normally white liquid crystal panel 31, the on-state pixels allow incident light to pass therethrough without changing the polarization of the light, and the off-state pixels allow incident light to pass therethrough after converting the polarization of the light. Accordingly, the on-state pixel of the normally white liquid crystal panel 31 will also be referred to as the “non-polarization conversion pixel”, and the off-state pixel will also be referred to as the “polarization conversion pixel”. In addition, the state of the screen portion that corresponds to the on-state pixel and is displayed in black will also be referred to as the “first display state”, and the state of the screen portion that corresponds to the off-state pixel and is displayed in white will also be referred to as the “second display state”.

<1.3 Light Transmission and Absorption where the Liquid Crystal Panel is being Provided with No Image Signal>

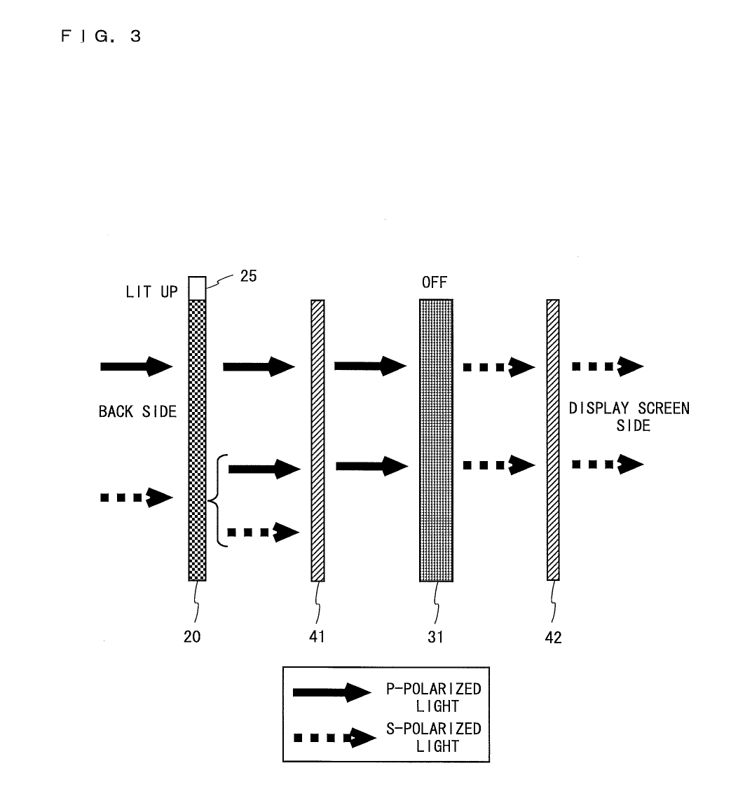

FIG. 3 is a diagram illustrating light transmission and absorption in the display 10 used for the basic study where all pixels of the liquid crystal panel 31 are in off-state. In this case, the display 10 functions as a transparent display.

As shown in FIG. 3, since the liquid crystal panel 31 is not being provided with any image signal, all pixels of the liquid crystal panel 31 are in off-state. In this case, the light source 25 is lit up, and therefore, light reflected from any object situated on the back side of the display 10, along with light emitted by the light guiding plate 20, reaches the display screen side. Accordingly, the viewer on the screen side visually recognizes light emitted by the light guiding plate 20, along with the light from the object situated on the back side of the display 10. In this case, since the light source 25 is lit up, light is emitted by the light guiding plate 20, as shown in FIG. 3. However, this light transmission and absorption is the same as in the case shown in the lower panel of FIG. 2, and therefore, any illustration thereof is omitted in FIG. 3.

Transmission and absorption of p-polarized light and s-polarized light by the off-state pixels will be described with reference to FIG. 3. P-polarized light included in the light from the object situated on the back side of the display is incident on the liquid crystal panel 31 after being transmitted through the light guiding plate 20 and the first absorptive polarizing plate 41. Moreover, s-polarized light is converted into p-polarized light and s-polarized light by the light guiding plate 20, and only the p-polarized light is transmitted through the first absorptive polarizing plate 41 and is incident on the liquid crystal panel 31. The p-polarized light transmitted through the first absorptive polarizing plate 41 is incident on the off-state pixels of the liquid crystal panel 31. The off-state pixels convert the incident p-polarized light into s-polarized light, and emit the s-polarized light toward the second absorptive polarizing plate 42. Since the second absorptive polarizing plate 42 transmits s-polarized light therethrough, the s-polarized light incident on the second absorptive polarizing plate 42 is transmitted through the second absorptive polarizing plate 42, and reaches the display screen side. In this case, all pixels of the liquid crystal panel 31 are in off-state, so that the screen is displayed in white, and light incident from the back side is transmitted to the display screen side.

Consequently, the entire screen corresponding to all pixels of the liquid crystal panel 31 is displayed in white, so that the entire display 10 functions as a transparent display, allowing the viewer on the display screen side to visually recognize the object situated on the back side through the liquid crystal panel 31.

The display 10 has been described above as entirely functioning as a transparent display when the light source 25 is lit up. Even in the case where the light source 25 is turned off in FIG. 3, the light from the object situated on the back side of the display 10 still reaches the display screen side. From this, it can be appreciated that the entire display 10 functions as a transparent display even when no light is being emitted by the light guiding plate 20.

<1.4 Configuration And Operation Of The Image Display Device>

The image display device used herein and including a display as described in detail in each embodiment below is a known image display device. While the image display device including the display 10 used for the basic study will be described herein, the same description can be applied to image display devices including displays to be described later in the embodiments.

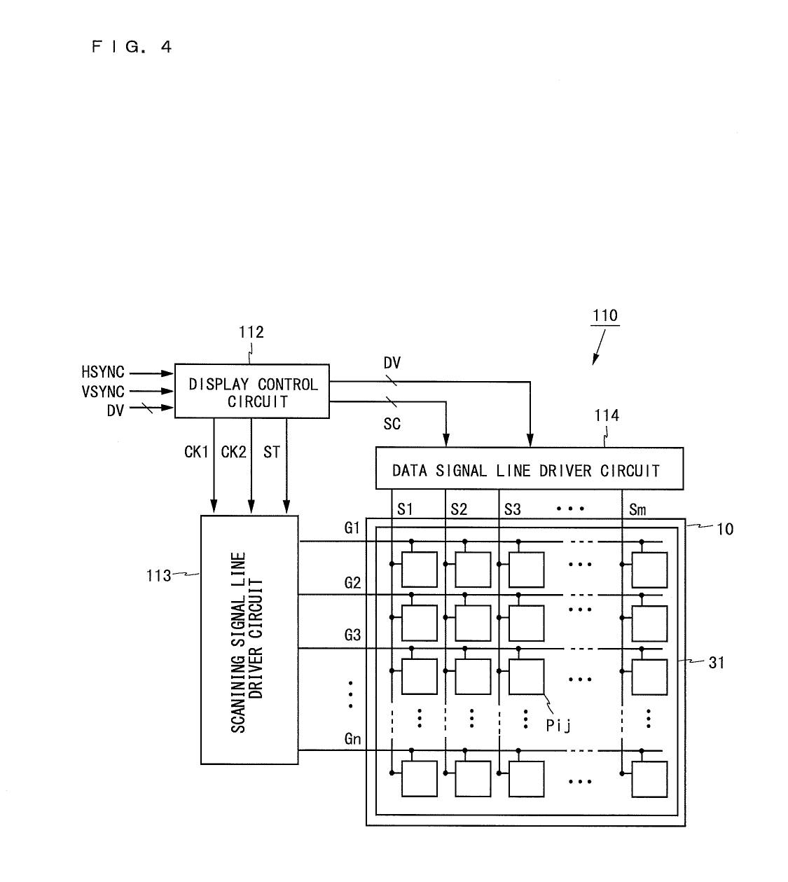

FIG. 4 is a block diagram illustrating the configuration of an image display device 110 including the display 10 shown in FIG. 1. The image display device 110 is an active-matrix image display device including the display 10, a display control circuit 112, a scanning signal line driver circuit 113, and a data signal line driver circuit 114, as shown in FIG. 4. In addition to the liquid crystal panel 31, the display 10 also includes a light guiding plate with a light source attached thereto and various polarizing plates, all of which are not shown in the figure.

The liquid crystal panel 31 included in the display 10 includes n scanning signal lines G₁ to Gₙ, m data signal lines S₁ to Sₘ, and (mXn) pixels Pᵢⱼ (where m is an integer greater than or equal to 2, and j is an integer greater than or equal to 1 but less than or equal to m). The scanning signal lines G₁ to Gₙ. are arranged parallel to one another, and the data signal lines S₁ to Sₘ are arranged parallel to one another so as to be perpendicular to the scanning signal lines G₁ to Gₘ. The pixel Pᵢⱼ is disposed near the intersection of the scanning signal line Gᵢ and the data signal line Sⱼ. In this manner, the (mXn) pixels Pᵢⱼ are arranged two-dimensionally such that each row includes m of the pixels and each column includes n of the pixels. The scanning signal line Gᵢ is connected commonly to the pixels Pᵢⱼ arranged in the i′th row, and the data signal line Sⱼ is connected commonly to the pixels Pᵢⱼ arranged in the j′th column.

The image display device 110 is externally supplied with control signals, such as a horizontal synchronization signal HSYNC and a vertical synchronization signal VSYNC, and an image signal DV1. In accordance with these signals, the display control circuit 112 outputs a clock signal CK and a start pulse ST to the scanning signal line driver circuit 113 and a control signal SC and the image signal DV1 to the data signal line driver circuit 114.

The scanning signal line driver circuit 113 provides a high-level output signal sequentially to each of the scanning signal lines G₁ to Gₙ. As a result, the scanning signal lines G₁ to Gₙ are sequentially selected one by one, so that the pixels Pᵢⱼ are simultaneously selected row by row. On the basis of the control signal SC and the image signal DV1, the data signal line driver circuit 114 provides the data signal lines S₁ to Sₘ with a signal voltage in accordance with the image signal DV1. Consequently, the signal voltage in accordance with the image signal DV1 is written to the pixels Pᵢⱼ in the selected row. In this manner, the image display device 110 displays an image on the liquid crystal panel 31.

<1.5 Findings from the Basic Study>

The Basic Study reveals that the display 10 displays the image based on the image signal DV1 provided to the liquid crystal panel 31, and the display 10 can be used as a transparent display. Accordingly, the viewer on the display screen side can visually recognize the image based on the image signal DV1, and also visually recognize the object situated on the back side through the liquid crystal panel 31. However, light emitted by the light guiding plate 20 toward the back side escapes from the display 10 to the outside, and therefore, cannot be used for image display. Therefore, the display 10 used for the basic study has a problem of low use efficiency of the light emitted by the light guiding plate 20.

Therefore, see-through image display devices capable of enhancing use efficiency of light emitted by the light guiding plate 20 will be described in each of the following embodiments.

### 2. First Embodiment

### 2.1 Configuration of the Display

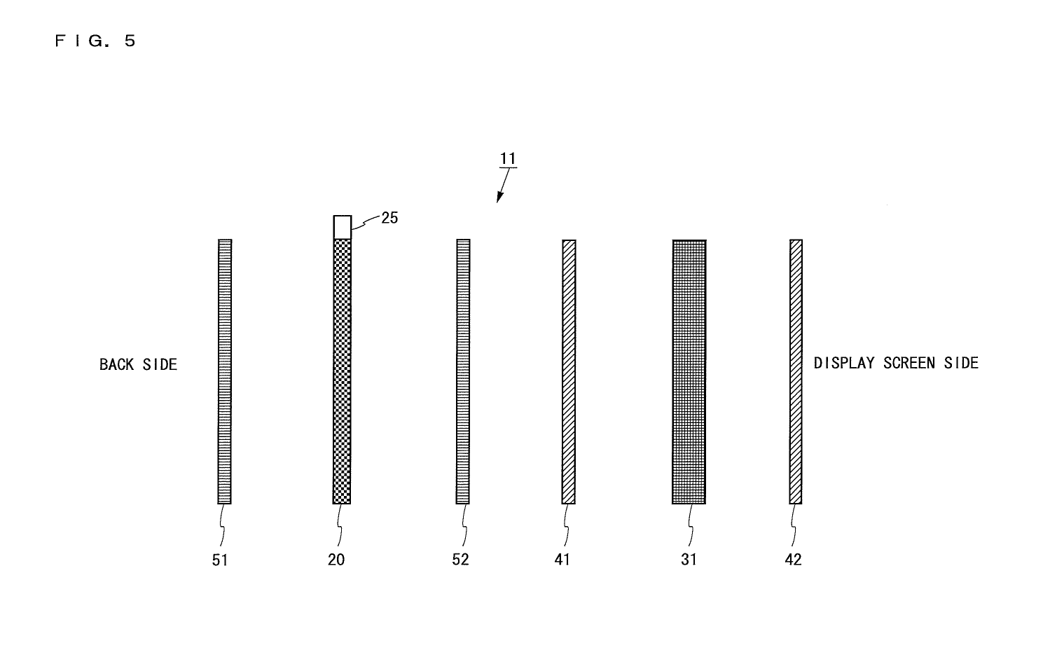

FIG. 5 is a diagram illustrating the configuration of a display 11 used in a see-through image display device according to a first embodiment of the present invention. As shown in FIG. 5, the display 11 in the present embodiment has two reflective polarizing plates 51 and 52 additionally disposed in the display 10 shown in FIG. 1. Accordingly, components of the display 11 in the present embodiment that are the same as those of the display 10 shown in FIG. 1 are denoted by the same reference characters, therefore, any descriptions thereof will be omitted, and different components will be mainly described.

Referring to FIG. 5, the first reflective polarizing plate 51 and the second reflective polarizing plate 52 are respectively arranged to the back side and the display screen side of the light guiding plate 20 such that the light guiding plate 20 is positioned therebetween. Both the first and second reflective polarizing plates 51 and 52 are reflective plates in the same phase as the first absorptive polarizing plate 41. That is, the first and second reflective polarizing plates 51 and 52 are polarizing plates which transmit p-polarized light therethrough and reflect s-polarized light. In addition, the light guiding plate 20 has the light source 25 attached at one end.

### 2.2 Light Transmission and Absorption where the Liquid Crystal Panel is being Provided with an Image Signal

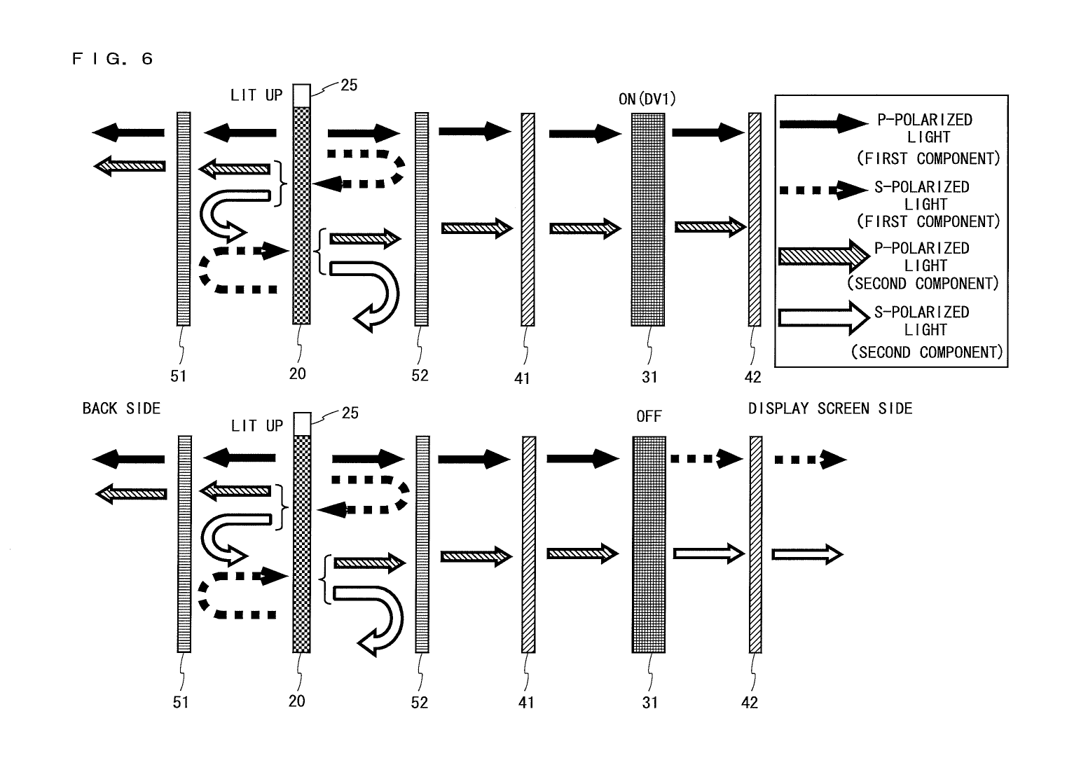

FIG. 6 is a diagram illustrating light transmission and absorption in the display 11 used in the present embodiment where the liquid crystal panel 31 is being provided with an image signal DV1; more specifically, the upper panel of FIG. 6 provides an illustration of light transmission and absorption where the pixels of the liquid crystal panel 31 are in on-state, and the lower panel of FIG. 6 provides an illustration of light transmission and absorption where the pixels of the liquid crystal panel 31 are in off-state.

First, transmission and absorption of p-polarized light and s-polarized light where the pixels of the liquid crystal panel 31 are in on-state will be described with reference to the upper panel of FIG. 6. P-polarized light and s-polarized light emitted by the light guiding plate 20 are incident on both the first reflective polarizing plate disposed on the back side and the second reflective polarizing plate 52 disposed on the display screen side. The p-polarized light and the s-polarized light incident on the first reflective polarizing plate 51 will now be described. In the following, the light initially emitted by the light guiding plate 20 will also be referred to as the “first-component” light, and the light generated by the light guiding plate 20 after being reflected by the first or second reflective polarizing plate 51 or 52 back to the light guiding plate 20 will also be referred to as the “second-component” light.

P-polarized first-component light incident on the first reflective polarizing plate 51 is transmitted through the first reflective polarizing plate 51 toward the back side. In contrast, s-polarized first-component light is reflected by the first reflective polarizing plate 51 back to the light guiding plate 20. The light guiding plate 20 generates p-polarized second-component light and s-polarized second-component light from the s-polarized first-component light reflected back, and emits the generated light toward the second reflective polarizing plate 52.

The p-polarized second-component light incident on the second reflective polarizing plate 52 is transmitted through the second reflective polarizing plate 52 toward the first absorptive polarizing plate 41. On the other hand, the s-polarized second-component light is reflected by the second reflective polarizing plate 52 back to the light guiding plate 20. The light guiding plate 20 generates p-polarized second-component light and s-polarized second-component light from the s-polarized second-component light reflected back, and emits the generated light toward the first reflective polarizing plate 51. Thereafter, the following are similarly repeated: the p-polarized light and the s-polarized light are incident on the first or second reflective polarizing plate 51 or 52, and only the p-polarized light is transmitted through the first or second reflective polarizing plate 51 or 52 while the s-polarized light experiences multiple reflection.

Furthermore, similar to the above, while the p-polarized first-component light and the s-polarized first-component light from the light guiding plate 20 are incident on the second reflective polarizing plate 52, only the p-polarized light is transmitted through the second reflective polarizing plate 52 toward the first absorptive polarizing plate 41. The s-polarized light is reflected by the second reflective polarizing plate 52 back to the light guiding plate 20. The light guiding plate 20 generates p-polarized second-component light and s-polarized second-component light from the s-polarized first-component light reflected back, and emits the generated light toward the first reflective polarizing plate 51. Thereafter, the following are similarly repeated: the p-polarized light is transmitted through the first or second reflective polarizing plate 51 or 52 while the s-polarized light experiences multiple reflection.

In this manner, the p-polarized first-component light and the p-polarized second-component light incident on the second reflective polarizing plate 52 are transmitted through the second reflective polarizing plate 52 toward the first absorptive polarizing plate 41. The s-polarized light is repeatedly reflected back to the light guiding plate 20 between the first reflective polarizing plate 51 and the second reflective polarizing plate 52, and used by the light guiding plate 20 for generating p-polarized second-component light and s-polarized second-component light.

The p-polarized first-component light and the p-polarized second-component light incident on the first absorptive polarizing plate 41 are transmitted through the first absorptive polarizing plate 41, and are incident on-state pixels of the liquid crystal panel 31. The on-state pixels transmit the p-polarized light therethrough toward the second absorptive polarizing plate 42 without changing the polarization of the light. However, the second absorptive polarizing plate 42 absorbs p-polarized light, and therefore, the p-polarized light incident on the second absorptive polarizing plate 42 is absorbed and is not transmitted to the display screen side. Consequently, screen portions that correspond to the on-state pixels are displayed in black.

Next, transmission and absorption of p-polarized light and s-polarized light by the off-state pixels will be described with reference to the lower panel of FIG. 6. In this case, as in the case of the upper panel of FIG. 6, only the p-polarized first-component light and the p-polarized second-component light emitted by the light guiding plate 20 are incident on the off-state pixels of the liquid crystal panel 31. The off-state pixels convert the incident p-polarized light into s-polarized light, and emit the s-polarized light toward the second absorptive polarizing plate 42. The s-polarized light is incident on the second absorptive polarizing plate 42, and the second absorptive polarizing plate 42 transmits the incident light therethrough to the display screen side. Consequently, screen portions that correspond to the off-state pixels are displayed in white.

In this manner, the pixels of the liquid crystal panel 31 that are provided with the image signal DV1 are brought into on-state, and their corresponding screen portions are displayed in black. Moreover, the pixels that are not provided with the image signal DV1 are in off-state, and their corresponding screen portions are displayed in white. Consequently, the liquid crystal panel 31 displays a monochrome (black and white) image consisting of the screen portions displayed in black and the screen portions displayed in white. Therefore, the viewer on the display screen side can visually recognize the monochrome image based on the image signal DV1.

The light that reaches the display screen side includes s-polarized light obtained through polarization conversion from the p-polarized second-component light, along with the s-polarized light obtained through polarization conversion from the p-polarized first-component light. Accordingly, the intensity of the light that reaches the display screen side is increased, resulting in increased contrast of a monochrome image to be displayed.

In this case, the p-polarized first-component light and the p-polarized second-component light are also transmitted through the first reflective polarizing plate 51 toward the back side. Consequently, the display 11 appears to be emitting light from the back surface to the viewer on the back side of the display 11.

<2.3 Light Transmission And Absorption Where The Liquid Crystal Panel Is Being Provided With No Image Signal>

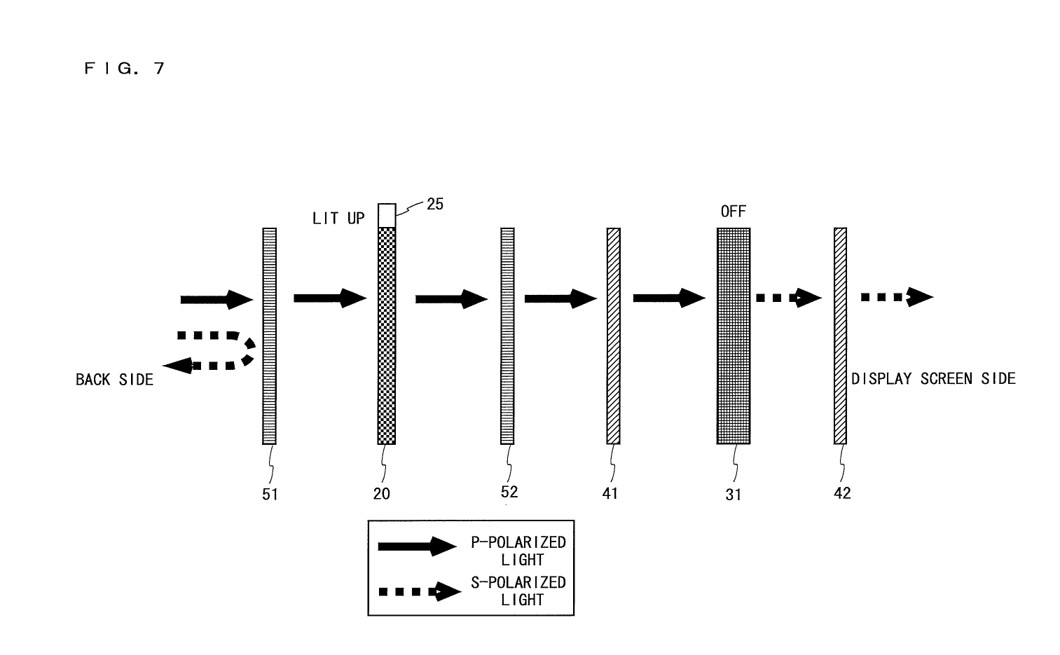

FIG. 7 is a diagram illustrating light transmission and absorption in the display 11 used in the present embodiment where all pixels of the liquid crystal panel 31 are in off-state. Referring to FIG. 7, s-polarized light from any object situated on the back side is reflected by the first reflective polarizing plate 51 whereas p-polarized light from the object is transmitted sequentially through the first reflective polarizing plate 51, the light guiding plate 20, the second reflective polarizing plate 52, and the first absorptive polarizing plate 41, and is incident on the off-state pixels of the liquid crystal panel 31. The off-state pixels convert the incident p-polarized light into s-polarized light, and emit the s-polarized light toward the second absorptive polarizing plate 42. The second absorptive polarizing plate 42 transmits s-polarized light therethrough, and therefore, the incident s-polarized light reaches the display screen side. In this case, since all pixels of the liquid crystal panel 31 are in off-state, the entire screen corresponding to the pixels is displayed in white, and the incident light from the back side is transmitted to the display screen side. Consequently, the entire display 11 functions as a transparent display, and the viewer on the display screen side can visually recognize the object situated on the back side through the liquid crystal panel 31. In this case, the light source 25 is lit up, as shown in FIG. 7, and therefore, the light guiding plate 20 emits light as well. Transmission and absorption of this light is similar to that in the case shown in the lower panel of FIG. 6, and therefore, any illustration thereof is omitted in FIG. 7.

Furthermore, s-polarized light incident from the back side of the display 11 is reflected by the first reflective polarizing plate 51, so that the back surface of the display 11 becomes specular and appears to be mirror-like to the viewer on the back side while reflecting the background.

The display 11 has been described above as entirely functioning as a transparent display where the light source 25 is lit up. However, even in the case where the light source 25 is turned off in FIG. 7, the light from the object situated on the back side of the display 10 still reaches the display screen side. From this, it can be appreciated that the entire display 10 functions as a transparent display even when no light is being emitted by the light guiding plate 20.

<2.4 Light Guiding Plate>

The light guiding plate 20 is made of a transparent resin such as acrylic or polycarbonate, and the light guiding plate 20 emits first-component light, including p-polarized light and s-polarized light emitted by the light source, toward the first and second reflective polarizing plates 51 and 52, and also reutilizes incident s-polarized light reflected back by the first and second reflective polarizing plates 51 and 52. The “reutilization” herein encompasses generation and emission of p-polarized second-component light and s-polarized second-component light from the s-polarized light reflected by the first reflective polarizing plate 51 or the second reflective polarizing plate 52 back to the light guiding plate 20. The p-polarized second-component light and the s-polarized second-component light are generated mainly through diffuse reflection within the light guiding plate 20. Note that the material with which to make the light guiding plate 20 is not limited to the aforementioned resins such as acrylic and polycarbonate, and any transparent material such as glass can be used so long as light is allowed to propagate therethrough.

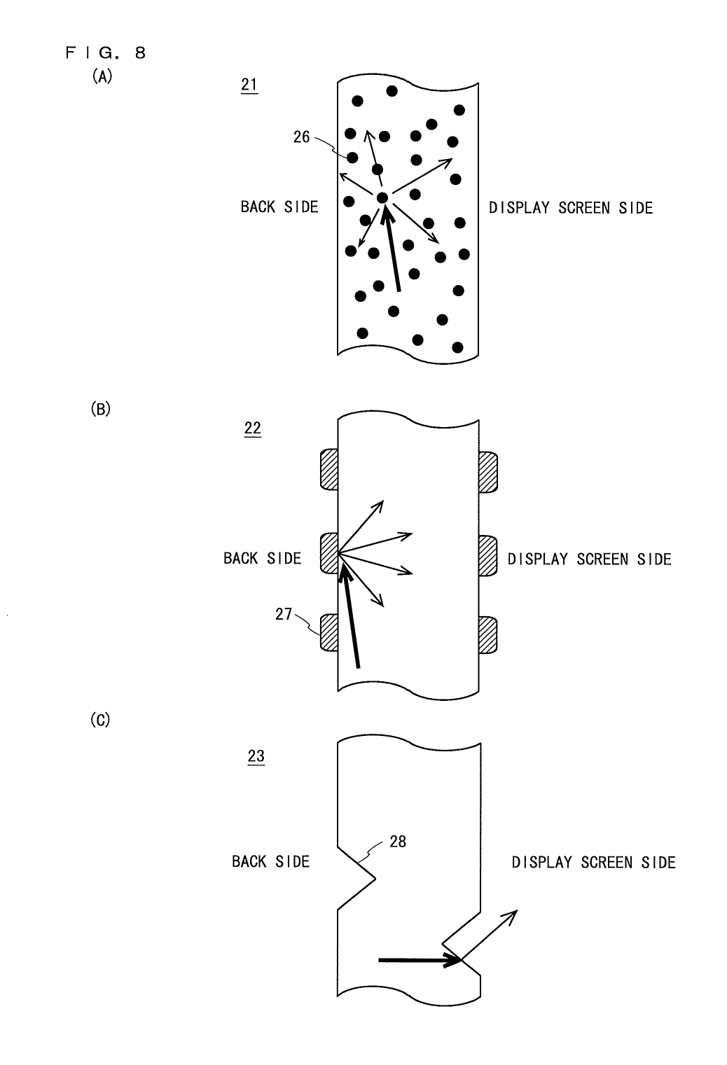

FIG. 8 provides cross-sectional views of light guiding plates adapted to cause diffuse reflection; more specifically, FIG. 8(A) is a cross-sectional view of a haze-controlled light guiding plate 21, FIG. 8(B) is a cross-sectional view of a light guiding plate 22 with dots 27 printed on opposite surfaces, and FIG. 8(C) is a cross-sectional view of a light guiding plate 23 with wedges 28 provided on opposite surfaces. Note that in the case of the light guiding plate 22 shown in FIG. 8(B), the dots 27 are provided on the opposite surfaces of the light guiding plate 22, but the dots 27 may be provided on only one of either the display screen-side surface or the back-side surface. Similarly, in FIG. 8(C), the wedges 28 may be provided on only one of either the display screen-side surface or the back-side surface of the light guiding plate 23.

The haze-controlled light guiding plate 21 will be described with reference to FIG. 8(A). To allow the light guiding plate 21 to readily cause diffuse reflection, transparent particles 26, such as silica, are incorporated in a transparent resin at the time of production.

Consequently, the degree of haze of the light guiding plate 21 is set within the range of from 2% to 3%. Here, the degree of haze is an index related to the transparency of the light guiding plate 20, which represents haziness (or opacity) and indicates the rate of diffusive transmission light to entire transmission light by a numerical value.

Note that the particles 26 to be incorporated are preferably about tens to hundreds micrometers in diameter, more preferably approximately 20 μm to 300 μm in diameter. In addition, the particles 26 are preferably circular, but may be conical or pyramidal.

Areas with a higher degree of haze can generate more s-polarized second-component light and more p-polarized second-component light from s-polarized light incident on the light guiding plate 20. Accordingly, the degree of haze may be set high around the center of the light guiding plate 20 and become lower toward the periphery, or may be set constant within a predetermined range from the center of the light guiding plate 20 and become lower on the outside of the range. This allows more light to be transmitted therethrough around the center of the liquid crystal panel 31, resulting in enhanced image quality.

P-polarized second-component light and s-polarized second-component light can be generated from s-polarized light not only through diffuse reflection but also through reutilization of s-polarized light obtained through interfacial reflection caused within the light guiding plate 21. However, when compared to diffuse reflection, interfacial reflection is less efficient at generation of s-polarized second-component light and p-polarized second-component light through reutilization, and therefore is less contributive to enhancement of image quality.

The light guiding plate 22, in which the dots 27 of transparent ink about the size of several micrometers are provided on the right and left light emission surfaces by inkjet printing, as shown in FIG. 8(B), may be used, or the light guiding plate 23 provided with the wedges 28 about the size of several micrometers, as shown in FIG. 8(C), may be used. However, in the case where the light guiding plate 22 with the printed dots 27 is used, there are some problems where the viewer readily notices the dots 27 in an image, and where the intensity of an image is low because the light guiding plate 22 emits light at a substantial angle to the normal line. Moreover, similar problems occur also in the case where the light guiding plate 23 provided with the wedges 28 is used. Therefore, as the best option for the light guiding plate 20 of the display 11, it is preferable to use the light guiding plate 21 with the degree of haze adjusted by incorporating the particles 26 therein.

### 2.5 Effects

In the present embodiment, the first reflective polarizing plate 51 and the second reflective polarizing plate 52 are arranged with the light guiding plate 20 positioned therebetween. Accordingly, s-polarized light emitted by the light guiding plate 20 toward the front screen side is reflected by the second reflective polarizing plate 52 back to the light guiding plate 20, and s-polarized light emitted toward the back side is reflected by the first reflective polarizing plate 51 also back to the light guiding plate 20. In this manner, the light emitted by the light guiding plate 20 toward the back side, along with the light emitted toward the display screen side, can be reutilized, resulting in enhanced use efficiency of the light emitted by the light guiding plate 20.

Furthermore, once the s-polarized light reflected by the first or second reflective polarizing plate 51 or 52 returns to the light guiding plate 20, the light guiding plate 20 generates p-polarized light and s-polarized light from the s-polarized light having returned, and emits the generated light again. This renders it possible to further enhance the use efficiency of the light emitted by the light guiding plate 20.

Furthermore, the screen portions that correspond to the on-state pixels of the liquid crystal panel 31 are displayed in black, and the screen portions that correspond to the off-state pixels are displayed in white. Accordingly, the viewer on the display screen side can visually recognize a monochrome image based on the image signal DV1, which consists of the screen portions displayed in black and the screen portions displayed in white. In this case, the p-polarized light emitted by the light guiding plate 20 toward the back side is transmitted through the first reflective polarizing plate 51 toward the back side, so that the display 11 appears to be emitting light from the back surface.

Furthermore, when all pixels of the liquid crystal panel 31 are in off-state, light incident from the back side of the display 11 is transmitted through the off-state pixels toward the display screen side, so that the viewer on the display screen side can visually recognize the object situated on the back side through the liquid crystal panel 31. Thus, the display 11 functions as a transparent display as well. In this case, the back surface of the display 11 becomes specular and reflects the background.

### 3. Second Embodiment

### 3.1 Configuration of the Display

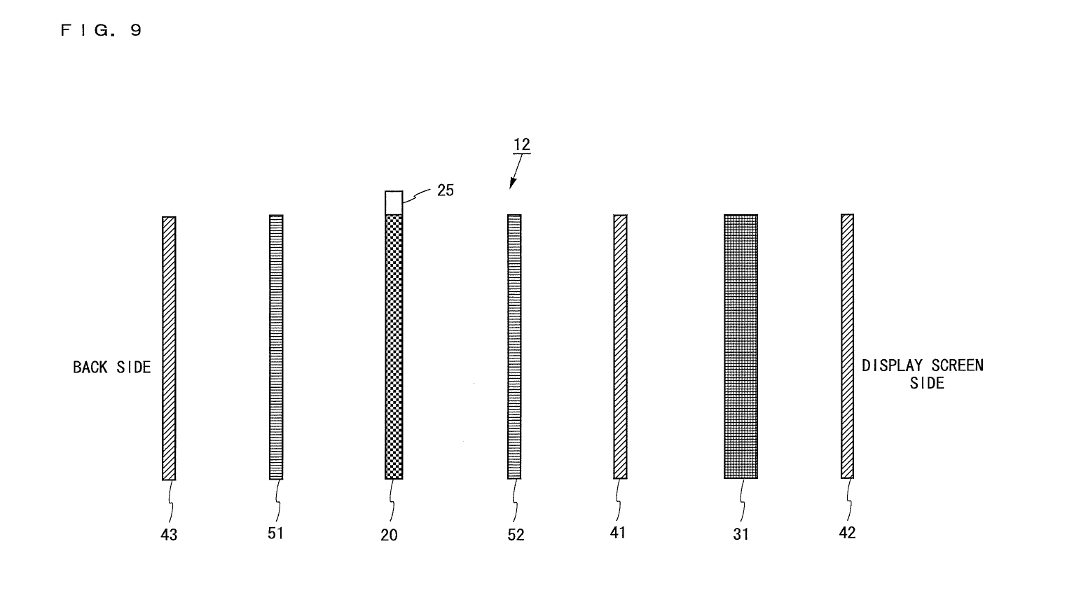

FIG. 9 is a diagram illustrating the configuration of a display 12 used in a see-through image display device according to a second embodiment of the present invention. As shown in FIG. 9, the display 12 in the present embodiment includes a third absorptive polarizing plate 43 additionally provided at the back of the display 11 shown in FIG. 5. Therefore, components of the display 12 in the present embodiment that are the same as those of the display 11 shown in FIG. 5 are denoted by the same reference characters, any descriptions thereof will be omitted, and different components will be mainly described.

As shown in FIG. 9, the third absorptive polarizing plate 43 is disposed on the back side relative to the first reflective polarizing plate 51. The third absorptive polarizing plate 43 is a polarizing plate which is in the same phase as the first reflective polarizing plate 51 and transmits p-polarized light while absorbing s-polarized light.

### 3.2 Light Transmission and Absorption where the Liquid Crystal Panel is being Provided with an Image Signal

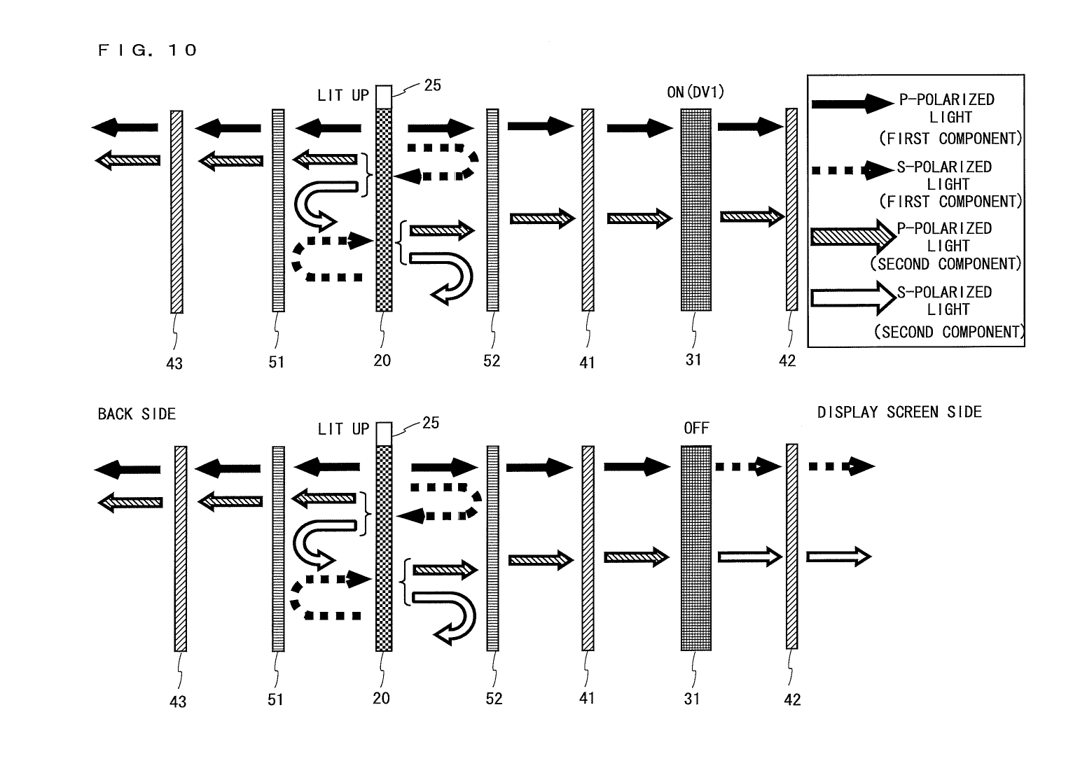

FIG. 10 is a diagram illustrating light transmission and absorption in the display 12 used in the second embodiment of the present invention where the liquid crystal panel 31 is being provided with an image signal DV1; more specifically, the upper panel of FIG. 10 provides an illustration of light transmission and absorption where the pixels of the liquid crystal panel 31 are in on-state, and the lower panel of FIG. 10 provides an illustration of light transmission and absorption where the pixels of the liquid crystal panel 31 are in off-state.

First, transmission and absorption of p-polarized light and s-polarized light in the display 12 where the pixels of the liquid crystal panel 31 are in on-state will be described with reference to the upper panel of FIG. 10. S-polarized first-component light emitted by the light guiding plate 20 and s-polarized second-component light generated by the light guiding plate 20 from the s-polarized first-component light are reused after returning to the light guiding plate 20 while experiencing multiple reflections between the first reflective polarizing plate 51 and the second reflective polarizing plate 52. As a result, the light guiding plate 20 generates and emits s-polarized second-component light and p-polarized second-component light. The p-polarized second-component light thus emitted, along with the p-polarized first component light, is transmitted through the second reflective polarizing plate and the first absorptive polarizing plate 41 and is incident on the liquid crystal panel 31. The p-polarized light incident on the pixels of the liquid crystal panel 31 which are in on-state while being provided with an image signal DV1 is transmitted therethrough without being subjected to polarization change, and is incident on the second absorptive polarizing plate 42. However, since the second absorptive polarizing plate 42 absorbs p-polarized light, neither the p-polarized first-component light nor the p-polarized second-component light incident on the second absorptive polarizing plate 42 reaches the display screen side. Therefore, the screen portions that correspond to the on-state pixels are displayed in black.

Next, transmission and absorption of p-polarized light and s-polarized light in the display 12 where the pixels of the liquid crystal panel 31 are in off-state will be described with reference to the lower panel of FIG. 10. In this case, as in the case shown in the upper panel of FIG. 10, p-polarized first-component light, along with second-component p-polarized light generated by the light guiding plate 20, is incident on the pixels of the liquid crystal panel 31 which are in off-state while not being provided with the image signal DV1. The off-state pixels convert the incident p-polarized light into s-polarized light, and emit the s-polarized light toward the second absorptive polarizing plate 42. Since the second absorptive polarizing plate 42 transmits s-polarized light therethrough, the s-polarized first-component light and the s-polarized second-component light incident on the second absorptive polarizing plate 42 are transmitted therethrough toward the display screen side. As a result, the screen portions that correspond to the off-state pixels are displayed in white.

In this manner, the pixels of the liquid crystal panel 31 that are provided with the image signal DV1 are brought into on-state, and their corresponding screen portions are displayed in black. Moreover, the pixels that are not provided with the image signal DV1 are in off-state, and their corresponding screen portions are displayed in white. As a result, the liquid crystal panel 31 displays a monochrome (black and white) image consisting of the screen portions displayed in black and the screen portions displayed in white. Thus, the viewer on the display screen side can visually recognize the monochrome image based on the image signal DV1.

Note that the light that reaches the display screen side includes s-polarized light obtained through polarization conversion from the p-polarized second-component light, along with the s-polarized light obtained through polarization conversion from the p-polarized first-component light. Accordingly, the intensity of the light that reaches the display screen side is increased, resulting in increased contrast of a monochrome image to be displayed.

Furthermore, when the light source 25 is lit up, the third absorptive polarizing plate 43 allows both the p-polarized first-component light and the p-polarized second-component light emitted by the light guiding plate 20 to be transmitted therethrough toward the back side regardless of whether the liquid crystal panel 31 is in on-state. Thus, the display 12 appears to be emitting light from the back surface to the viewer on the back side of the display 12.

### 3.3 Light Transmission and Absorption where the Liquid Crystal Panel is being Provided with No Image Signal

<3.3.1 Observation from the Display Screen Side>

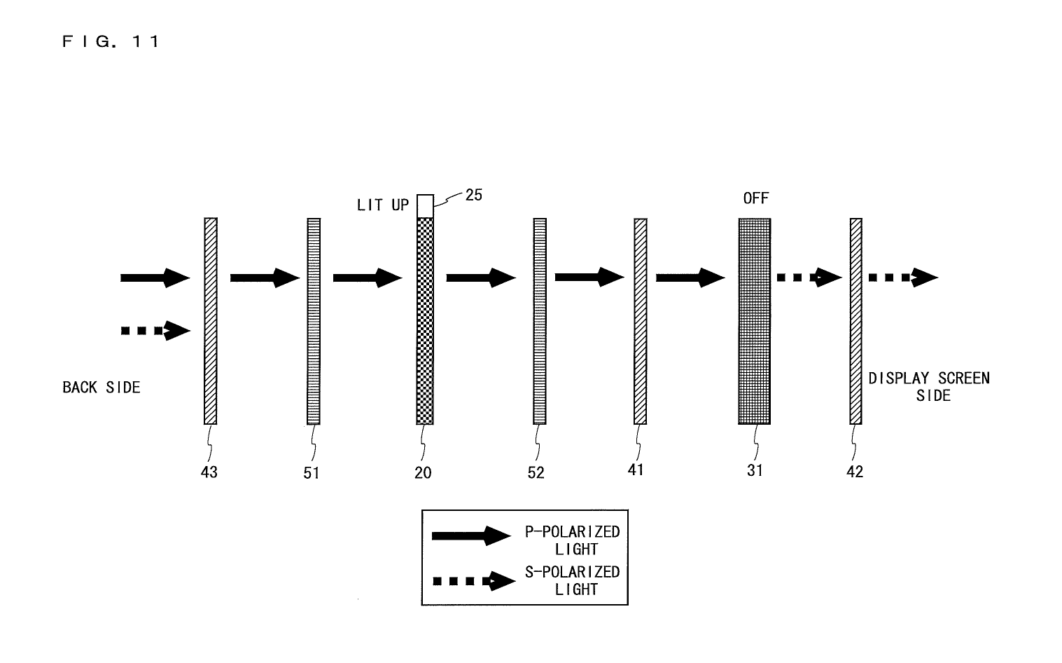

FIG. 11 is a diagram illustrating transmission and absorption of light from any object situated on the back side in the display 12 used in the second embodiment of the present invention where all pixels of the liquid crystal panel 31 are in off-state. Transmission and absorption of p-polarized light and s-polarized light by the off-state pixels will be described with reference to FIG. 11. S-polarized light from the object situated on the back side of the display 12 is absorbed by the third absorptive polarizing plate 43, and p-polarized light from the object is transmitted through the third absorptive polarizing plate 43. The p-polarized light transmitted through the third absorptive polarizing plate 43 is transmitted sequentially through the first reflective polarizing plate 51, the light guiding plate 20, the second reflective polarizing plate 52, and the first absorptive polarizing plate 41, and is incident on the off-state pixels of the liquid crystal panel 31. The off-state pixels convert the incident p-polarized light into s-polarized light, and emit the s-polarized light toward the second absorptive polarizing plate 42. Since the second absorptive polarizing plate 42 transmits s-polarized light therethrough, the s-polarized light incident on the second absorptive polarizing plate 42 reaches the display screen side. In this case, all pixels of the liquid crystal panel are in off-state, and therefore, their corresponding screen portions are displayed in white, and the light incident from the back side is transmitted toward the display screen side. Thus, the entire display 12 functions as a transparent display, and the viewer on the display screen side can visually recognize the object situated on the back side through the liquid crystal panel 31.

Furthermore, the s-polarized light included in the light incident on the third absorptive polarizing plate 43 from the back side is absorbed by the third absorptive polarizing plate 43 whereas the p-polarized light included in the incident light is transmitted through the third absorptive polarizing plate 43 and further propagates through the inside of the display 12. Thus, unlike in the case shown in FIG. 7, the back surface of the display 12 does not become specular.

### 3.3.2 Observation from the Back Side

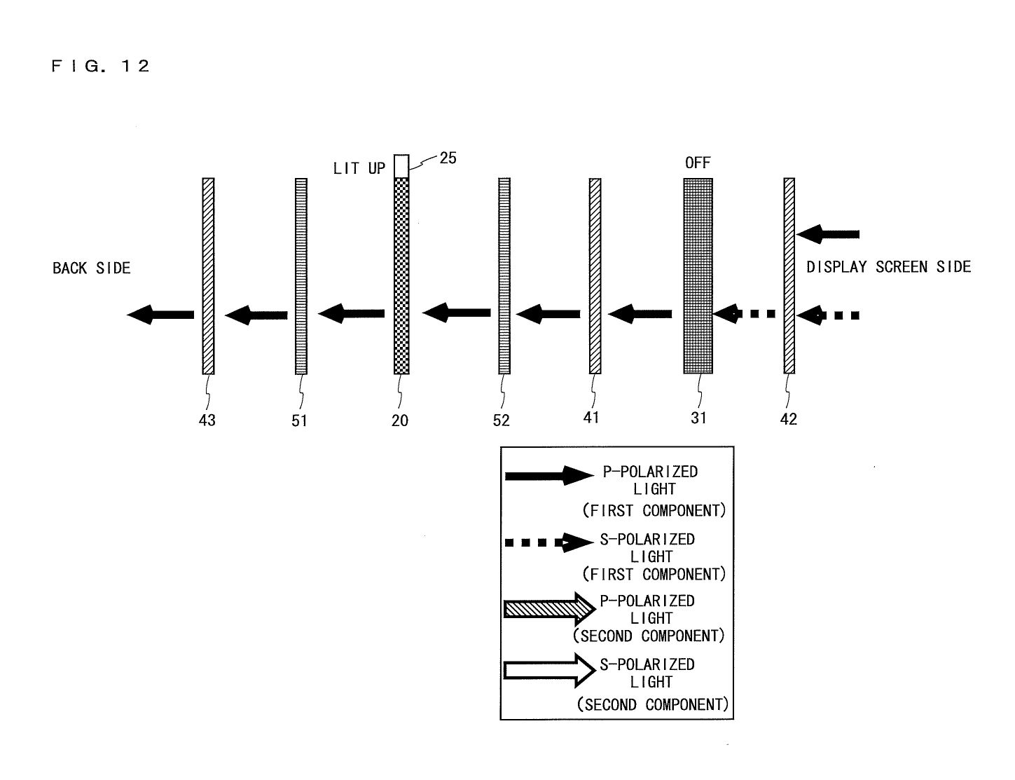

FIG. 12 is a diagram illustrating transmission and absorption of light from an object situated on the display screen side in the display 12 used in the second embodiment of the present invention where all pixels of the liquid crystal panel 31 are in off-state. As shown in FIG. 12, p-polarized light from the object situated on the display screen side is absorbed by the second absorptive polarizing plate 42. However, s-polarized light from the object is transmitted through the second absorptive polarizing plate 42, and is incident on the off-state pixels of the liquid crystal panel 31. The off-state pixels subject the incident s-polarized light to polarization conversion into p-polarized light, and emit the p-polarized light toward the first absorptive polarizing plate 41. The p-polarized light incident on the first absorptive polarizing plate 41 is transmitted sequentially through the second reflective polarizing plate 52, the light guiding plate 20, the first reflective polarizing plate 51, and the third absorptive polarizing plate 43, and reaches the back side. As a result, the screen portions that correspond to the off-state pixels are displayed in white, and the incident light from the display screen side is transmitted toward the back side. In this case also, the entire display 12 functions as a transparent display, so that the viewer on the back side can visually recognize the object situated on the display screen side through the liquid crystal panel 31. Here, the light source 25 is kept on, but as in the case shown in FIG. 11, the light source 25 may be turned off.

Note that the second absorptive polarizing plate 42 allows the s-polarized light incident from the display screen side to be transmitted therethrough toward the inside of the display 12 while absorbing the p-polarized light, and therefore, the front surface of the display 12 neither appears to be emitting light nor becomes specular.

Furthermore, as for both of the above cases, the display 12 has been described as entirely functioning as a transparent display when the light source 25 is lit up. However, even in the case where the light source 25 is turned off in FIG. 11, the light from the object situated on the back side of the display 11 still reaches the display screen side. In FIG. 12 also, even in the case where the light source 25 is turned off, the light from the object situated on the front screen side of the display 11 still reaches the display screen side. From the above, it can be appreciated that the entire display 11 functions as a transparent display even when no light is being emitted by the light guiding plate 20.

### 3.4 Effects

The present embodiment renders it possible to enhance use efficiency of light emitted by the light guiding plate 20, and also achieve the following effects. When the light source 25 is lit up, screen portions that correspond to on-state pixels of the liquid crystal panel 31 are displayed in black in accordance with the image signal DV1 whereas screen portions that correspond to off-state pixels are displayed in white. As a result, the liquid crystal panel 31 displays a monochrome (black and white) image consisting of the screen portions displayed in black and the screen portions displayed in white. Accordingly, the viewer on the display screen side can visually recognize the monochrome image based on the image signal DV1. In this case, p-polarized light included in the light emitted by the light guiding plate 20 toward the back side is transmitted through the second reflective polarizing plate 52 and the third absorptive polarizing plate 43, and reaches the back side, so that the entire back surface of the display 12 appears to be emitting light to the viewer on the back side.

Furthermore, when all pixels of the liquid crystal panel 31 are in off-state, the entire screen is displayed in white. Accordingly, light incident from the back side of the display 12 reaches the display screen side, so that the viewer on the display screen side can visually recognize the object situated on the back side through the entire liquid crystal panel 31. At the same time, light incident from the display screen side of the display 12 reaches the back side, and therefore, the viewer on the back side can visually recognize the object situated on the display screen side through the entire liquid crystal panel 31. In this manner, the display 12 functions as a transparent display when viewed from either the display screen side or the back side.

### 4. Third Embodiment

### 4.1 Display Configuration

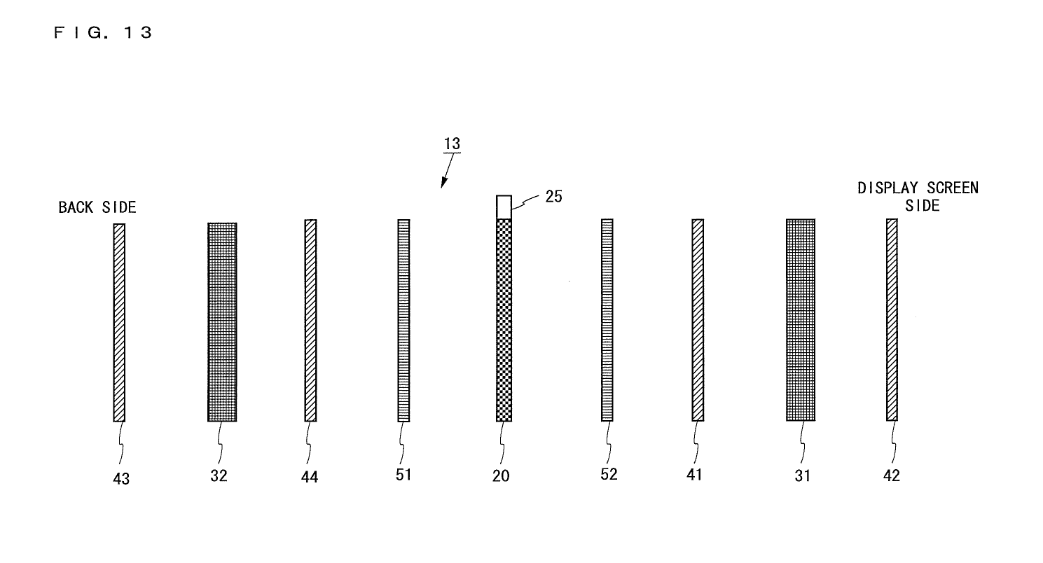

FIG. 13 is a diagram illustrating the configuration of a display 13 used in a see-through image display device according to a third embodiment of the present invention. As shown in FIG. 13, the display 13 in the present embodiment is the same as the display 11 shown in FIG. 5 in terms of component arrangement from the first reflective polarizing plate 51 located to the left of the light guiding plate 20 to the second absorptive polarizing plate 42 located on the display screen side. Moreover, in order from the first reflective polarizing plate 51 toward the back side, there are arranged a fourth absorptive polarizing plate 44, a liquid crystal panel 32, and the third absorptive polarizing plate 43. In other words, it can be said that these components are arranged so as to be horizontally line-symmetrical with respect to the light guiding plate 20. Alternatively, it can also be said that either the configuration up to the second absorptive polarizing plate 42 on the display screen side, including the first and second reflective polarizing plates 51 and 52 disposed with the light guiding plate 20 positioned therebetween, or the configuration up to the third absorptive polarizing plate 43 on the back side, including the first and second reflective polarizing plates 51 and 52 disposed with the light guiding plate 20 positioned therebetween, is the same as the configuration of the display 11 shown in FIG. 5. Therefore, the components of the display 13 in the present embodiment that are the same as those of the display 11 shown in FIG. 5 are denoted by the same reference characters, and different components will be mainly described.

The third absorptive polarizing plate 43 additionally provided in the present embodiment is an absorptive polarizing plate in the same phase as the second absorptive polarizing plate 42, and transmits s-polarized light therethrough while absorbing p-polarized light. The fourth absorptive polarizing plate 44 is an absorptive polarizing plate in the same phase as the first absorptive polarizing plate 41, and transmits p-polarized light therethrough while absorbing s-polarized light. Moreover, in the present embodiment, the liquid crystal panel 31 will also be referred to as the first liquid crystal panel 31, and the liquid crystal panel 32 will also be referred to as the second liquid crystal panel 32. Both the first and second liquid crystal panels 31 and 32 are normally white liquid crystal panels. In addition, the first liquid crystal panel 31 is externally provided with a first image signal DV1, and the second liquid crystal panel 32 is externally provided with a second image signal DV2. The first and second image signals DV1 and DV2 may be the same image signal or different image signals.

### 4.2 Transmission and Absorption where Liquid Crystal Panels are being Provided with Image Signals

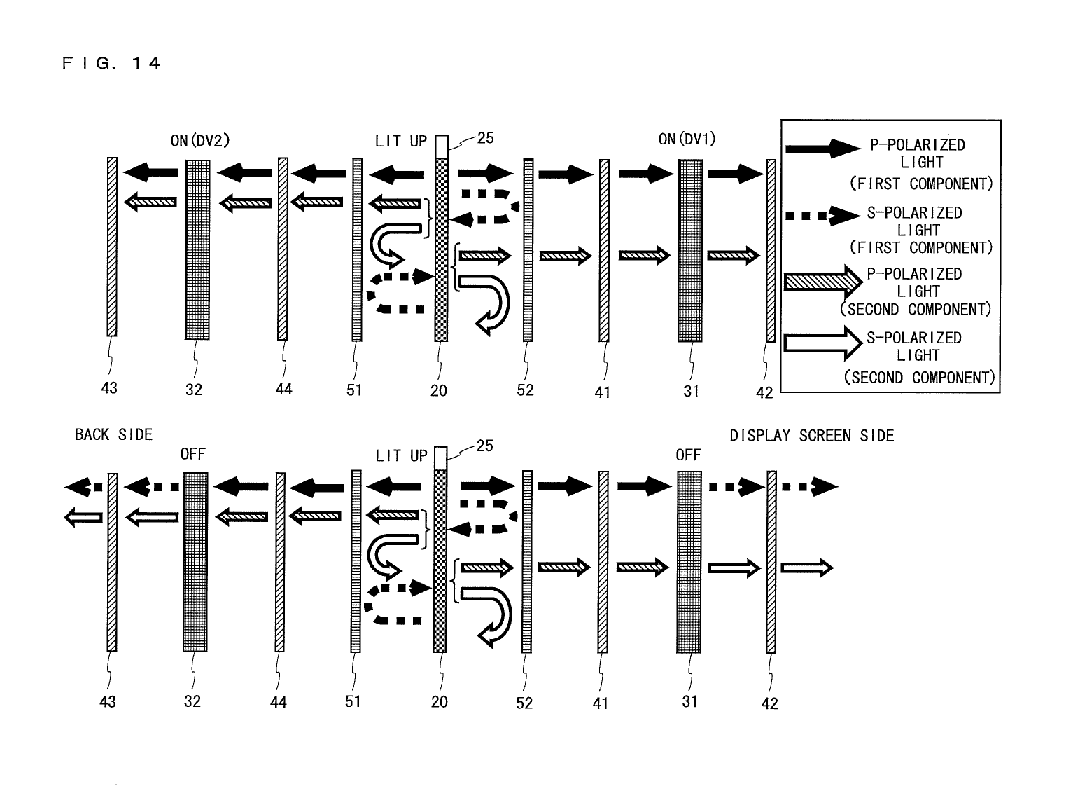

FIG. 14 is a diagram illustrating light transmission and absorption in the display 13 used in the third embodiment of the present invention where the first and second liquid crystal panels 31 and 32 are being provided with the first and second image signals DV1 and DV2, respectively. More specifically, the upper panel of FIG. 14 provides an illustration of light transmission and absorption where all pixels of both the first liquid crystal panel 31 and the second liquid crystal panel 32 are in on-state, and the lower panel of FIG. 14 provides an illustration of light transmission and absorption where all pixels of both the first liquid crystal panel 31 and the second liquid crystal panel 32 are in off-state.

First, transmission and absorption of p-polarized light and s-polarized light where the pixels of the first liquid crystal panel 31 are in on-state will be described with reference to the upper panel of FIG. 14. As described above, the configuration from the first reflective polarizing plate 51 to the second absorptive polarizing plate 42 on the display screen side is the same as that of the display 11 in the first embodiment shown in FIG. 5. Accordingly, as in the first embodiment, both p-polarized first-component light and p-polarized second-component light emitted by the light guiding plate 20 toward the display screen side are absorbed by the second absorptive polarizing plate 42 and therefore are not transmitted to the display screen side. Moreover, both the s-polarized first-component light and the s-polarized second-component light are reflected by the second reflective polarizing plate 52 and experiences multiple reflection between the first reflective polarizing plate 51 and the second reflective polarizing plate 52, so that neither the s-polarized first-component light nor the s-polarized second-component light is transmitted through the second absorptive polarizing plate 42 to the display screen side. In this manner, neither the p-polarized light nor the s-polarized light emitted by the light guiding plate 20 is transmitted to the display screen side, so that screen portions that correspond to the on-state pixels of the first liquid crystal panel 31 are displayed in black.

Next, transmission and absorption of p-polarized light and s-polarized light by the on-state pixels of the second liquid crystal panel 32 will be described. As described above, the configuration from the second reflective polarizing plate 52 to the third absorptive polarizing plate 43 on the back side is the same as the configuration from the first reflective polarizing plate 51 to the second absorptive polarizing plate 42 on the display screen side. In this case also, neither p-polarized light nor s-polarized light emitted by the light guiding plate 20 is transmitted through the third absorptive polarizing plate 43 to the back side, so that screen portions that correspond to the on-state pixels of the second liquid crystal panel 32 are displayed in black.

Next, transmission and absorption of p-polarized light and s-polarized light where the pixels of the first liquid crystal panel 31 are in off-state will be described with reference to the lower panel of FIG. 14. In the case where the pixels of the liquid crystal panel 31 are in off-state, as in the case where the pixels are in on-state, both p-polarized first-component light emitted by the light guiding plate 20 and p-polarized second-component light emitted by the light guiding plate 20 after being generated through reutilization by the light guiding plate 20 are transmitted through the second reflective polarizing plate 52 and the first absorptive polarizing plate 41 and are incident on the off-state pixels of the first liquid crystal panel 31. The off-state pixels subject the incident p-polarized light to polarization conversion into s-polarized light, and emit the s-polarized light toward the second absorptive polarizing plate 42. Since the second absorptive polarizing plate 42 transmits s-polarized light therethrough, the s-polarized light incident on the second absorptive polarizing plate 42 reaches the display screen side. Accordingly, screen portions that correspond to the off-state pixels of the first liquid crystal panel 31 are displayed in white.

Likewise, both p-polarized first-component light and p-polarized second-component light emitted by the light guiding plate 20 toward the back side are converted into s-polarized light by the second liquid crystal panel 32, and transmitted through the third absorptive polarizing plate 43 to the back side. Accordingly, screen portions that correspond to the off-state pixels of the second liquid crystal panel 32 are displayed in white.

In this manner, the pixels of the first liquid crystal panel 31 that are being provided with the first image signal DV1 are brought into on-state, and their corresponding screen portions are displayed in black. Moreover, the pixels that are not provided with the first image signal DV1 are in off-state, and their corresponding screen portions are displayed in white. Similarly, the pixels of the second liquid crystal panel 32 that are being provided with the second image signal DV2 are brought into on-state, and their corresponding screen portions are displayed in black. In addition, the pixels that are not provided with the second image signal DV2 are in off-state, and their corresponding screen portions are displayed in white. Consequently, the viewer on the display screen side can visually recognize a monochrome image displayed on the first liquid crystal panel 31 in accordance with the first image signal DV1. Moreover, the viewer on the back side can visually recognize a monochrome image displayed on the second liquid crystal panel 32 in accordance with the second image signal DV2.

Furthermore, the light that reaches the display screen side or the back side includes s-polarized light obtained through polarization conversion from the p-polarized second-component light, along with the s-polarized light obtained through polarization conversion from the p-polarized first-component light. Accordingly, the intensity of the light that reaches the display screen side or the back side is increased, resulting in increased contrast of a monochrome image to be displayed.

### 4.3 Effects

The present embodiment renders it possible to enhance use efficiency of light emitted by the light guiding plate 20 as with the first embodiment, and also achieve the following effects. By providing the first and second image signals DV1 and DV2 to the first and second liquid crystal panels 31 and 32, respectively, some of the pixels of the first and second liquid crystal panels 31 and 32 are brought into on-state, and the rest of the pixels are kept in off-state. Accordingly, the display 13 provides a monochrome image based on the first image signal DV1 on the display screen side and a monochrome image based on the second image signal DV2 on the back side. In this case, when the first image signal DV1 and the second image signal DV2 are the same image signal, the viewer on the display screen side and the viewer on the back side visually recognize the same image. Moreover, when the first image signal DV1 and the second image signal DV2 are different image signals, the viewer on the display screen side and the viewer on the back side visually recognize different images.

Furthermore, the light emitted by the light guiding plate 20 toward the display screen side or the back side is used as backlight to illuminate the first liquid crystal panel 31 or the second liquid crystal panel 32. Thus, the use efficiency of the light emitted by the light guiding plate 20 can be further enhanced.

### 5. Fourth Embodiment

### 5.1 Display Configuration

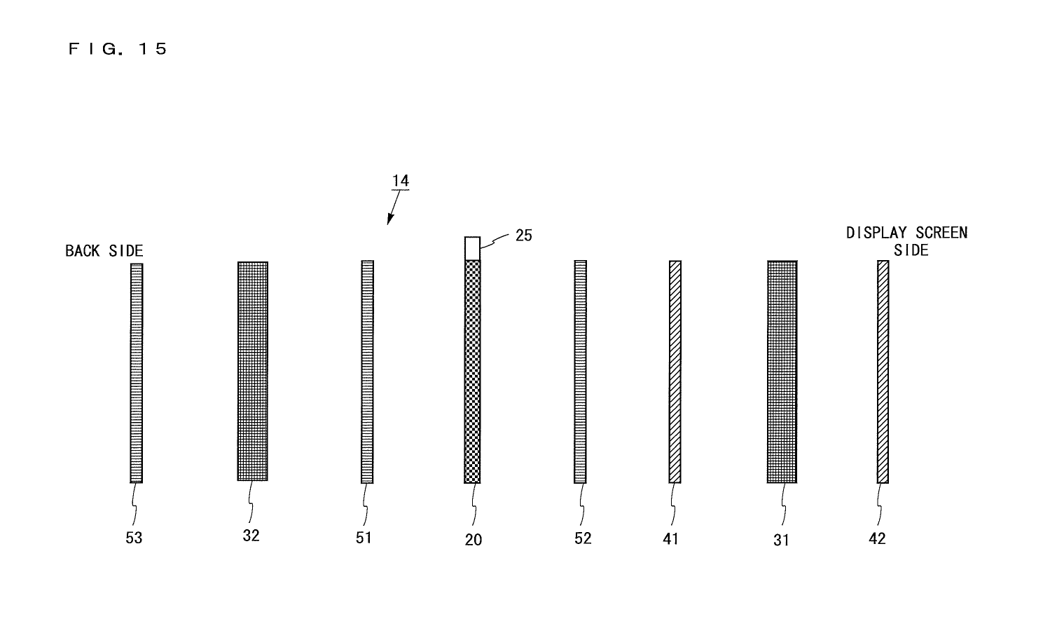

FIG. 15 is a diagram illustrating the configuration of a display 14 used in a see-through image display device according to a fourth embodiment of the present invention. As shown in FIG. 15, the display 14 in the present embodiment is the same as the display 11 shown in FIG. 5 in terms of component arrangement from the first reflective polarizing plate 51 located on the back side relative to the light guiding plate 20 to the second absorptive polarizing plate 42 located on the display screen side. Moreover, in order from the first reflective polarizing plate 51 to the back side, there are arranged the second liquid crystal panel 32 and a third reflective polarizing plate 53. Therefore, components of the display 14 in the present embodiment that are the same as those of the display 11 shown in FIG. 5 are denoted by the same reference characters, any descriptions thereof will be omitted, and different components will be mainly described.

The third reflective polarizing plate 53 additionally provided in the present embodiment is a reflective polarizing plate in the same phase as the first and second reflective polarizing plates 51 and 52, and transmits p-polarized light therethrough while absorbing s-polarized light. Moreover, in the present embodiment, the liquid crystal panel 31 will also be referred to as the first liquid crystal panel 31, and the liquid crystal panel 32 will also be referred to as the second liquid crystal panel 32. Both the first and second liquid crystal panels 31 and 32 are normally white liquid crystal panels.

### 5.2 Light Transmission and Absorption where the Liquid Crystal Panels are being Provided with Image Signals

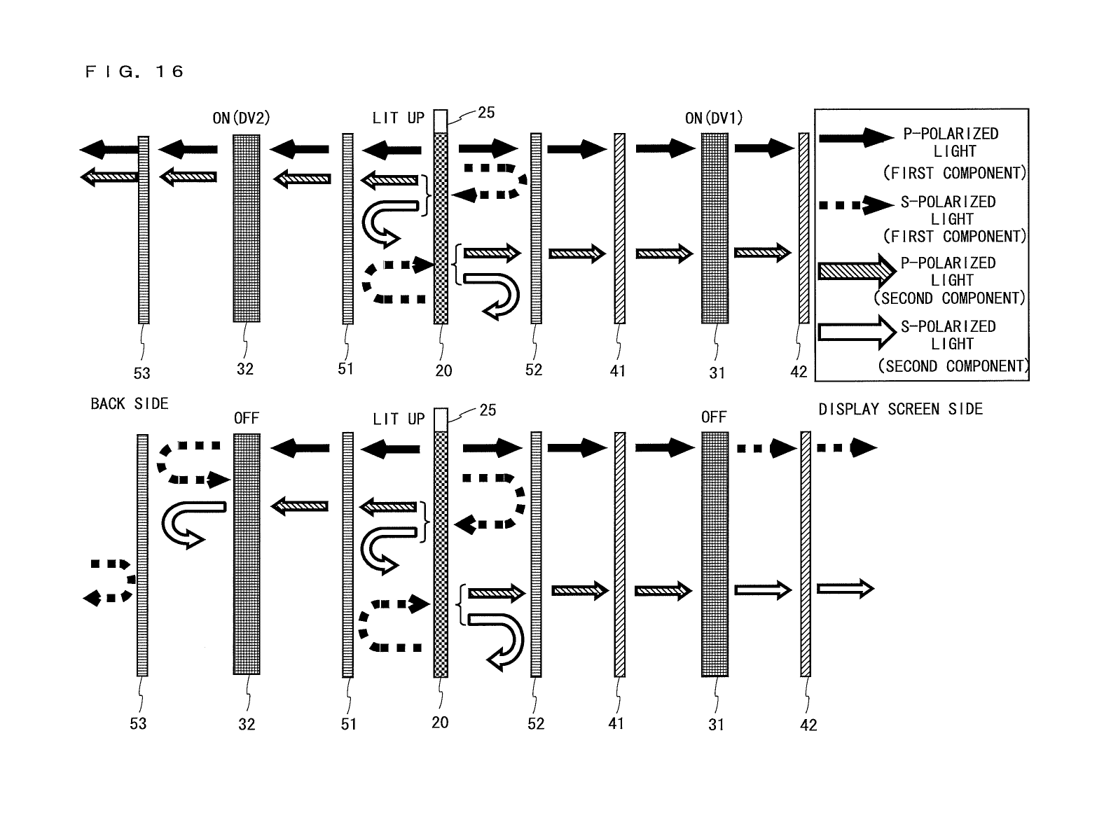

FIG. 16 is a diagram illustrating light transmission and absorption in the display 14 used in the fourth embodiment of the present invention where the first and second liquid crystal panels 31 and 32 are being provided with first and second image signals DV1 and DV2, respectively. More specifically, the upper panel of FIG. 16 provides an illustration of light transmission and absorption where all pixels of both the first liquid crystal panel 31 and the second liquid crystal panel 32 are in on-state, and the lower panel of FIG. 16 provides an illustration of light transmission and absorption where all pixels of both the first liquid crystal panel 31 and the second liquid crystal panel 32 are in off-state. The first liquid crystal panel 31 is externally provided with the first image signal DV1, and the second liquid crystal panel 32 is externally provided with the second image signal DV2. The first image signal DV1 and the second image signal DV2 may be the same image signal or may be different image signals.

### 5.2.1 Display as Viewed from the Display Screen Side

The display state of the screen of the display 14 as viewed from the display screen side will be described. Described first is the case where the pixels of the first liquid crystal panel 31 are in on-state, as shown in the upper panel of FIG. 16. The configuration from the first reflective polarizing plate 51 to the second absorptive polarizing plate 42 on the display screen side is the same as in the display 11 in the first embodiment shown in FIG. 5. Accordingly, as in the first embodiment, p-polarized first-component light and p-polarized second-component light are transmitted through all components up to the first liquid crystal panel 31 in on-state, but are absorbed by the second absorptive polarizing plate 42 without being transmitted to the display screen side. In addition, s-polarized first-component light and s-polarized second-component light are multiply reflected between the first reflective polarizing plate 51 and the second reflective polarizing plate 52, and therefore are not transmitted through the second reflective polarizing plate 52 toward the display screen side. In this manner, neither the p-polarized light nor the s-polarized light emitted by the light guiding plate 20 is transmitted to the display screen side, so that the screen portions that correspond to the on-state pixels of the first liquid crystal panel 31 are displayed in black.

Next, in the case shown in the lower panel of FIG. 16, as in the case shown in the lower panel of FIG. 14, p-polarized first-component light and p-polarized second-component light are transmitted through the first absorptive polarizing plate 41 and are incident on the first liquid crystal panel 31. The p-polarized light incident on the off-state pixels of the liquid crystal panel 31 is converted into s-polarized light, and the s-polarized light is emitted toward the second absorptive polarizing plate 42. The s-polarized light incident on the second absorptive polarizing plate 42 is transmitted through the second absorptive polarizing plate 42 and reaches the display screen side. Consequently, the screen portions that correspond to the off-state pixels of the first liquid crystal panel 31 are displayed in white.

In this manner, the pixels of the first liquid crystal panel 31 that are being provided with the first image signal DV1 are brought into on-state, and their corresponding screen portions are displayed in black. In addition, the pixels that are not provided with the first image signal DV1 are in off-state, and their corresponding screen portions are displayed in white. Consequently, the first liquid crystal panel 31 displays a monochrome (black and white) image consisting of the screen portions displayed in black and the screen portions displayed in white. Thus, the viewer on the display screen side can visually recognize the monochrome image based on the first image signal DV1.

Note that the light that reaches the display screen side includes s-polarized light obtained through polarization conversion from the p-polarized second-component light, along with the s-polarized light obtained through polarization conversion from the p-polarized first-component light. Accordingly, the intensity of the light that reaches the display screen side is increased, resulting in increased contrast of a monochrome image to be displayed.

### 5.2.2 Display as Viewed from the Back Side

The display state of the screen of the display 14 as viewed from the back side will be described. First, the case where the pixels of the second liquid crystal panel 32 are in on-state will be described with reference to the upper panel of FIG. 16. As for the light emitted by the light guiding plate 20 toward the back side, s-polarized first-component light and s-polarized second-component light are multiply reflected between the first reflective polarizing plate 51 and the second reflective polarizing plate 52, and therefore, are not transmitted through the first reflective polarizing plate 51 toward the back side.

Furthermore, p-polarized first-component light and p-polarized second-component light are transmitted through the first reflective polarizing plate 51 and are incident on the second liquid crystal panel 32. The on-state pixels of the second liquid crystal panel 32 emit the incident p-polarized light toward the third reflective polarizing plate 53 without changing the polarization of the light. Since the third reflective polarizing plate 53 transmits p-polarized light therethrough, the p-polarized light incident on the third reflective polarizing plate 53 reaches the back side. In this case, the second liquid crystal panel 32 is being provided with the second image signal DV2, and therefore, the second liquid crystal panel 32 displays an image based on the second image signal DV2. Consequently, the viewer on the back side can visually recognize the image based on the second image signal DV2.

Note that in the case shown in the lower panel of FIG. 16 where the pixels of the second liquid crystal panel 32 are in off-state, p-polarized first-component light and p-polarized second-component light incident on the second liquid crystal panel 32 are transmitted through the second liquid crystal panel 32 and thereby respectively converted into s-polarized first-component light and s-polarized second-component light, and thereafter, the s-polarized first-component light and the s-polarized second-component light are reflected by the third reflective polarizing plate 53. Accordingly, neither the p-polarized light nor the s-polarized light emitted by the light guiding plate 20 reaches the back side.

In this case, the third reflective polarizing plate 53 reflects s-polarized light incident from the back side, so that the back surface of the display 14 becomes specular and therefore appears to be mirror-like to the viewer on the back side wile reflecting the background.

### 5.3 Light Transmission and Absorption where the Liquid Crystal Panels are being Provided with No Image Signals

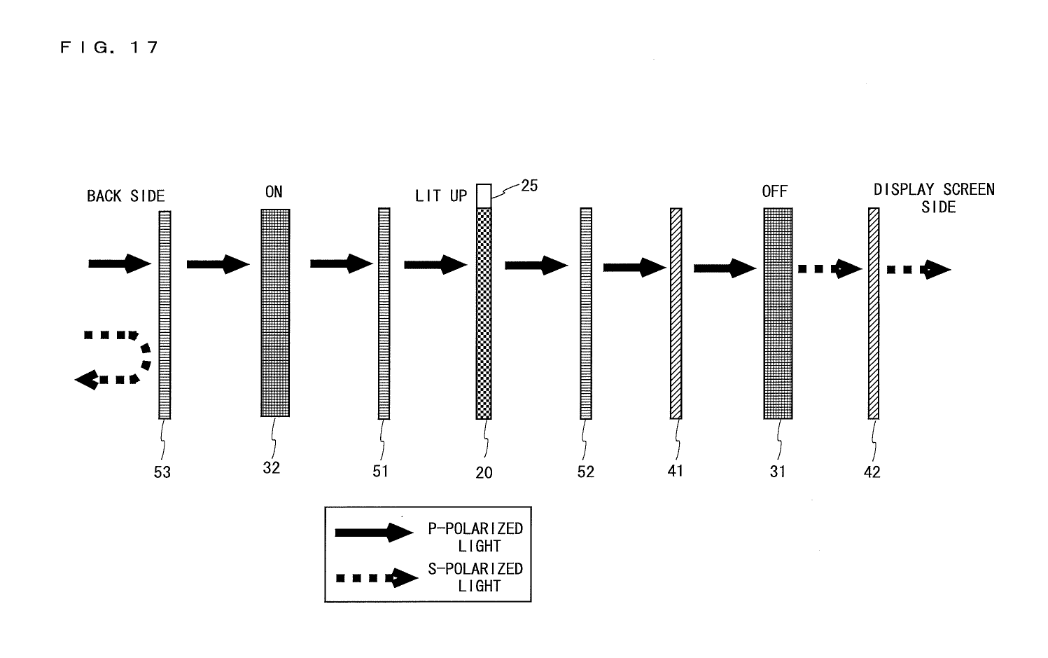

FIG. 17 is a diagram illustrating transmission and absorption of light from any object situated on the back side of the display 14 used in the fourth embodiment of the present invention where all pixels of the first liquid crystal panel 31 are in off-state, and all pixels of the second liquid crystal panel 32 are in on-state.

In order to allow the p-polarized light incident from the back side of the display 14 and transmitted through the third reflective polarizing plate 53 to be transmitted through the second absorptive polarizing plate 42 to the display screen side, the incident p-polarized light needs to be converted into s-polarized light within the display 14. To this end, the second liquid crystal panel 32 transmits the incident p-polarized light therethrough without changing the polarization of the light, and the first liquid crystal panel 31 converts the p-polarized light into s-polarized light, and transmits the s-polarized light therethrough. Therefore, all pixels of the second liquid crystal panel 32 are set in on-state, whereas all pixels of the first liquid crystal panel 31 are set in off-state.

As for the light from the object situated on the backside of the display 14, s-polarized light is reflected by the third reflective polarizing plate 53, as shown in FIG. 17. However, p-polarized light is transmitted through the third reflective polarizing plate 53, and is incident on the pixels of the second liquid crystal panel 32. Since all of the pixels of the second liquid crystal panel 32 are in on-state, the pixels emit the incident p-polarized light toward the first reflective polarizing plate 51 without changing the polarization of the light. The emitted p-polarized light is transmitted through the first reflective polarizing plate 51, the light guiding plate 20, the second reflective polarizing plate 52, and the first absorptive polarizing plate 41, and is incident on the first liquid crystal panel 31. Since all pixels of the first liquid crystal panel 31 are in off-state, the pixels convert the p-polarized light into s-polarized light, and emit the s-polarized light toward the second absorptive polarizing plate 42. The s-polarized light incident on the second absorptive polarizing plate 42 is transmitted through the second absorptive polarizing plate 42 and reaches the display screen side.

In this manner, all pixels of the second liquid crystal panel 32 are brought into on-state, and all pixels of the first liquid crystal panel 31 are kept in off-state, so that the screen of the display 14 is displayed in white. As a result, the viewer on the display screen side can visually recognize the object situated on the back side of the display 14 through the first and second liquid crystal panels 31 and 32.

In this case, p-polarized light from the object situated on the back side of the display 14 is transmitted through the second liquid crystal panel 32 whose transmittance is controlled in accordance with the second image signal DV2. Thus, the viewer on the display screen side can visually recognize an image of the object situated on the back side being displayed in gradations.

Furthermore, the third reflective polarizing plate 53 reflects s-polarized light included in the light incident from the back side of the display 14. Thus, the back surface of the display 14 becomes specular and appears to be mirror-like while reflecting the background.

Note that the display 14 has been described above as entirely functioning as a transparent display when the light source 25 is lit up. However, even in the case where the light source 25 is turned off in FIG. 17, the light from the object situated on the back side of the display 14 still reaches the display screen side. From this, it can be appreciated that the entire display 14 functions as a transparent display even when no light is being emitted by the light guiding plate 20.

### 5.4 Effects

The present embodiment renders it possible to enhance use efficiency of light emitted by the light guiding plate 20 as with the first embodiment, and also achieve the following effects. The display 14 is the same as the display 12 in the second embodiment shown in FIG. 9 in terms of the configuration from the light guiding plate 20 to the second absorptive polarizing plate 42. Thus, the viewer on the display screen side can visually recognize a monochrome image based on the first image signal DV1 when the light source 25 is lit up.

In this case, when the first image signal DV1 and the second image signal DV2 are the same signal, the viewer on the display screen side and the viewer on the back side can visually recognize the same image. Alternatively, when the first image signal DV1 and the second image signal DV2 are different signals, the viewer on the display screen side and the viewer on the back side can visually recognize different images.

Furthermore, p-polarized light included in the light emitted by the light guiding plate 20 toward the back side reaches the back side. Accordingly, the viewer on the back side can visually recognize a monochrome image based on the second image signal DV2. In this case, the third reflective polarizing plate 53 reflects light incident from the back side, and therefore, the surface thereof becomes specular and displays the monochrome image on the mirror-like surface reflecting the background.

Furthermore, when the pixels of the first liquid crystal panel 31 are in off-state, and the pixels of the second liquid crystal panel 32 are in on-state, p-polarized light incident from the back side is transmitted sequentially through the on-state pixels of the second liquid crystal panel 32 and the off-state pixels of the first liquid crystal panel 31, and reaches the display screen side. Consequently, the viewer on the display screen side can visually recognize the object situated on the back side through the first and second liquid crystal panels 31 and 32. At this time, the back surface of the display 14 becomes specular and reflects the background, and therefore, the back surface of the display 14 appears to be mirror-like to the viewer on the back side while reflecting the background.

<6. Common Variants Among the Embodiments>

Hereinafter, common variants among the first through fourth embodiments will be described. While the variants will be described with respect to the display 11 in the first embodiment for the sake of convenience, the same variants can be applied to the second through fourth embodiments.

### 6.1 First Variant

In the first embodiment, the image that is displayed on the display screen of the display 11 has been described as a monochrome image. However, it is rendered possible to display a color image by slightly changing the configuration of the display 11. More specifically, it is conceivable to dispose a color filter or drive the light source 25 in field sequential mode. Both of these configurations are known and therefore will only be described briefly.

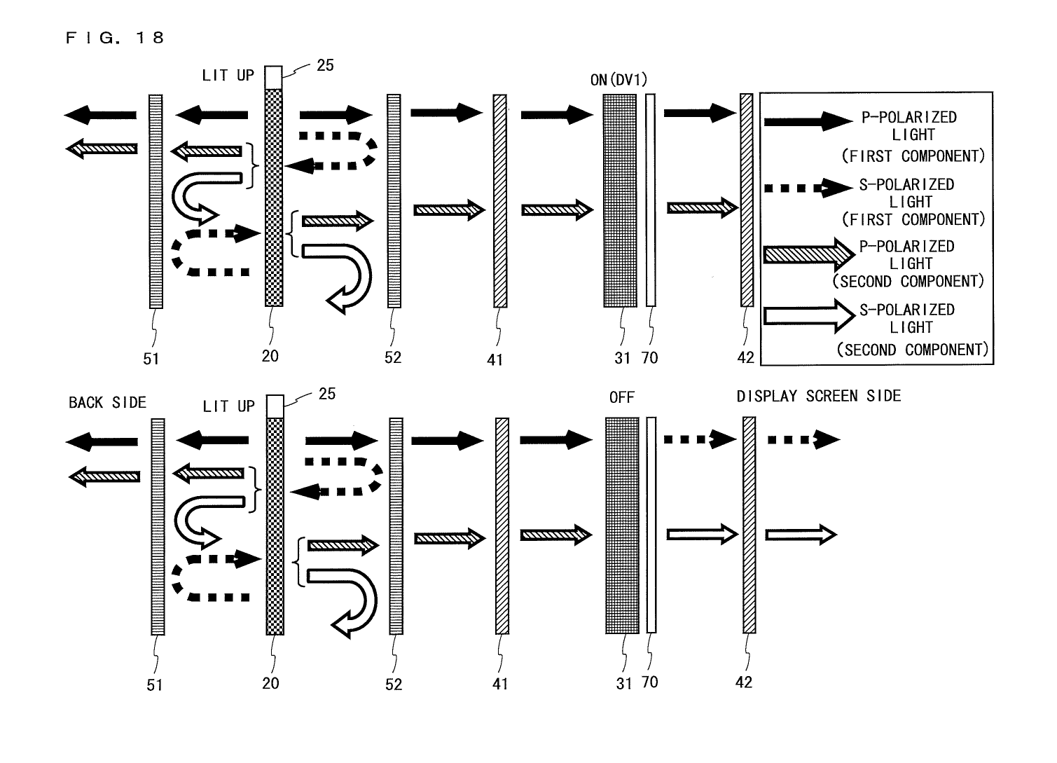

FIG. 18 is a diagram illustrating the configuration of a display which is a first variant of the display 11 shown in FIG. 5. The display shown in FIG. 18 has a color filter 70 disposed between the liquid crystal panel 31 and the second absorptive polarizing plate 42 in the display 11 shown in FIG. 5. Accordingly, display components in the present variant that are the same as those of the display 11 shown in FIG. 5 are denoted by the same reference characters, therefore, any descriptions thereof will be omitted, and different components will be mainly described.

As shown in FIG. 18, the color filter 70 of the display is attached to the surface of the liquid crystal panel 31 on the display screen side. The color filter 70 has a plurality of pixels consisting of, for example, R (red), G (green), and B (blue) sub-pixels and arranged in a matrix. The color filter 70 may be attached to the entire surface of the liquid crystal panel 31 or may be attached to a portion of the surface of the liquid crystal panel 31. The color filter 70 absorbs a portion of the light transmitted therethrough; however, in the case where the color filter 70 is attached a portion of the liquid crystal panel 31, there is no absorption of the light transmitted through the pixels of the liquid crystal panel 31 on which the color filter 70 is not attached. Thus, the viewer can visually recognize a high-intensity monochrome image.

Furthermore, each of the display 13 in the third embodiment and the display 14 in the fourth embodiment includes the second liquid crystal panel 32, along with the first liquid crystal panel 31. Accordingly, by attaching a color filter to the second liquid crystal panel 32, as in the case of the first liquid crystal panel 31, it is rendered possible to allow the viewer on the back side to visually recognize a color image displayed on the second liquid crystal panel 32 or a color image of the object situated on the display screen side.

Furthermore, in the case of field sequential drive, the light source 25 is controlled to emit light, for example, sequentially in R, G, and B in a time division manner and illuminate the liquid crystal panel 31. Accordingly, the viewer on the display screen side can visually recognize a color image. This eliminates the need to attach the color filter 70 to the liquid crystal panel 31, and therefore, the viewer can visually recognize a high-intensity color image. In addition, in the case where the display 11 is used as a transparent display, as in the case shown in FIG. 7, the object situated on the back side can be displayed in color.

Note that the light emitted by the light source 25 in a time division manner is directed by the light guiding plate 20 toward not only the display screen side but also the back side. The light directed toward the back side is transmitted through the second liquid crystal panel 32 as used in the display 13 in the third embodiment and the display 14 in the fourth embodiment. Accordingly, the viewer on the back side can visually recognize a color image based on the second image signal DV2 and can also visually recognize a color image of the object situated on the display screen side through the second liquid crystal panel 32.

<6.2 Second Variant>

In the first embodiment, the image that is displayed on the display screen of the display 11 has been described above as a monochrome image displayed in a single tone of black and a single tone of white. The monochrome image is an image not displayed in gradations. However, the display can also provide monochrome image display in gradations.

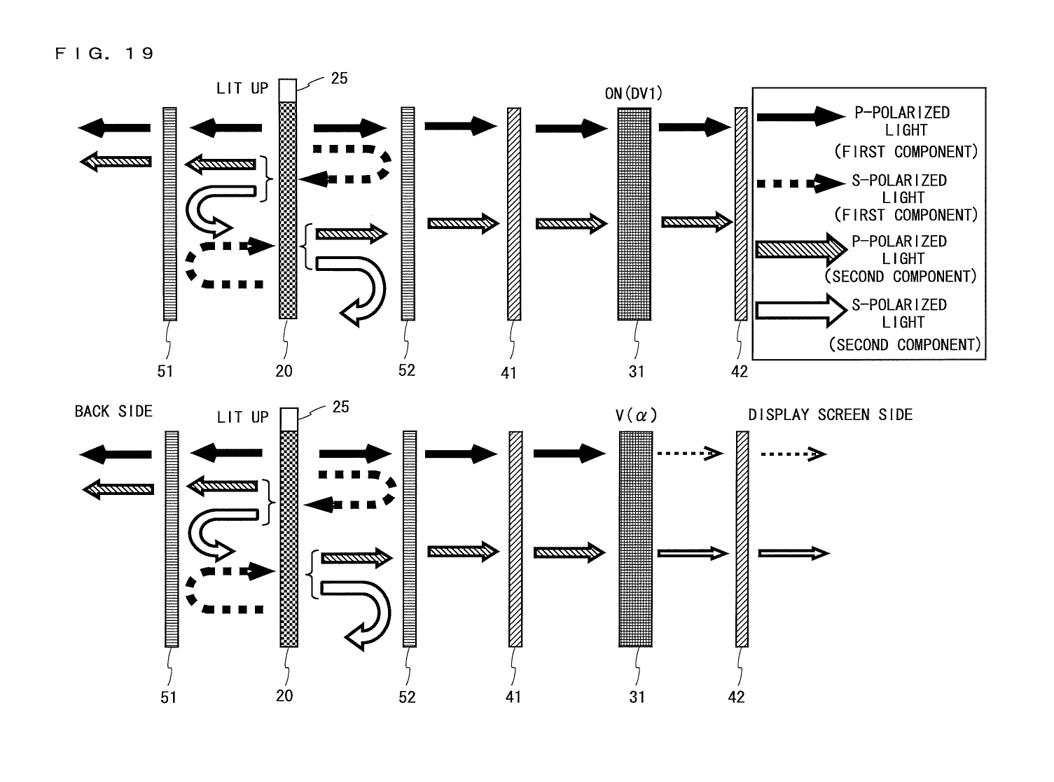

Therefore, the case where the monochrome image that is to be displayed on the display screen of the display 11 is displayed in gradations will now be described. FIG. 19 is a diagram illustrating light transmission and absorption in the display 11 in the first embodiment shown in FIG. 5 where gradation display is provided in accordance with an image signal provided to the liquid crystal panel 31; more specifically, the upper panel of FIG. 19 provides an illustration of light transmission and absorption where the pixels of the liquid crystal panel 31 are in on-state, and the lower panel of FIG. 19 provides an illustration of light transmission and absorption where the pixels of the liquid crystal panel 31 are provided with a voltage to provide gradation display (gradation display voltage).

First, light transmission and absorption where the pixels of the liquid crystal panel 31 are in on-state will be described with reference to FIG. 19. As in the case shown in the upper panel of FIG. 6, light emitted by the light guiding plate 20 is transmitted through the on-state pixels of the liquid crystal panel 31 and is incident on the second absorptive polarizing plate 42, by which the light is absorbed. As a result, screen portions that correspond to the on-state pixels are displayed in black.

Next, referring to the lower panel of FIG. 19, light emitted by the light guiding plate 20 is transmitted through the first absorptive polarizing plate 41 and is incident on the pixels of the liquid crystal panel 31, as in the case shown in the lower panel of FIG. 6. The pixels of the liquid crystal panel 31 are provided with a gradation display voltage. The gradation display voltage is a predetermined voltage V(α) higher than 0V at which p-polarized light is converted into s-polarized light by changing the polarization direction of the p-polarized light by 90 degrees, but the predetermined voltage V(α) is lower than a voltage V(0) at which to keep the polarization direction of the p-polarized light unchanged. Here, a represents an angle by which to change the polarization direction of the p-polarized light, and the voltage V(α) represents a voltage at which to change the polarization direction of the p-polarized light by α degrees. The polarization direction of light transmitted through pixels to which the voltage V (α) is being applied is changed by α degrees, such that the light includes a predetermined ratio of p-polarized light and s-polarized light. When such light is incident on the second absorptive polarizing plate 42, the p-polarized light is absorbed, and only the s-polarized light is transmitted through the second absorptive polarizing plate 42 and reaches the display screen side. For example, when a voltage V(45) to set the angle α at 45 degrees is applied to the liquid crystal panel 31, the pixels of the liquid crystal panel 31 convert incident p-polarized light into 50% p-polarized light and 50% s-polarized light. Accordingly, the intensity of the s-polarized light that reaches the display screen side is half the intensity of the p-polarized light whose polarization direction has not yet been changed.

In this manner, the intensity of the s-polarized light that reaches the display screen side can be controlled by adjusting the angle α and applying the voltage V(α) corresponding to the angle α to the pixels of the liquid crystal panel 31. In this case, screen portions that correspond to the pixels with α-degree polarization are displayed in a color midway between black and white, i.e., gray.

As a result, the screen portions that correspond to the pixels of the liquid crystal panel 31 that are being provided with the image signal DV1 are displayed in black, and the pixels that are being provided with the voltage V(α) are displayed in gray with a tone determined by the angle α. As a result, the liquid crystal panel 31 provides a monochrome image displayed in gradations. Thus, the viewer on the display screen side can visually recognize the monochrome image displayed in gradations in accordance with the image signal DV1. In addition, even in the case where the display 11 is used as a transparent display, the object situated on the back side can be displayed in gradations as in the case shown in FIG. 7.

### 6.3 Third Variant

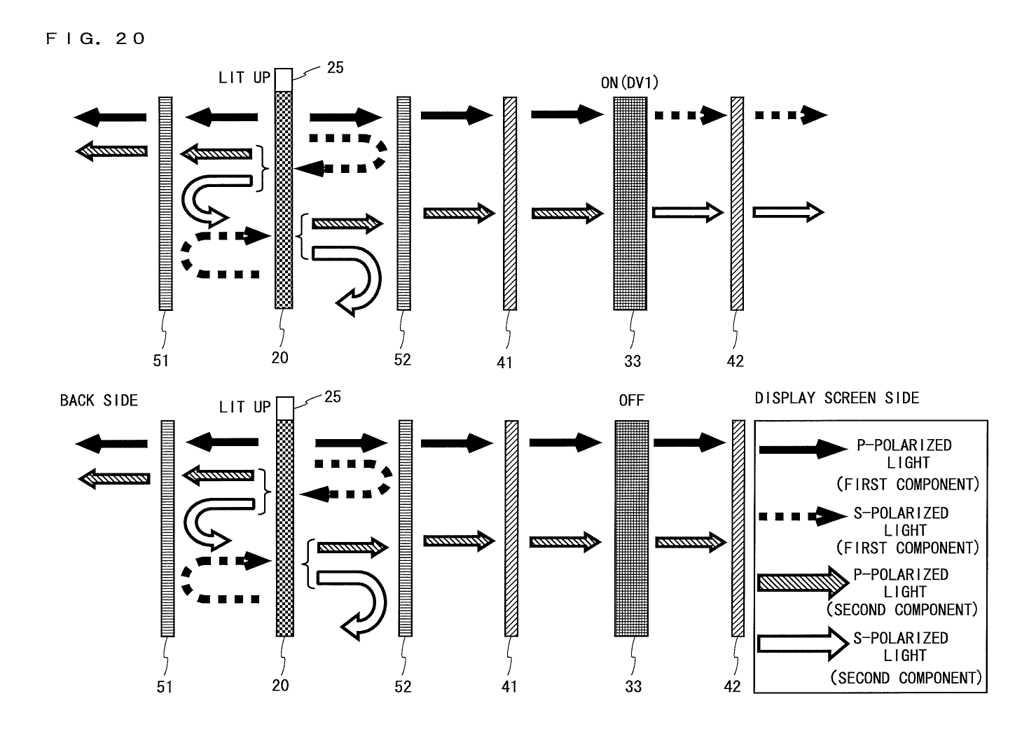

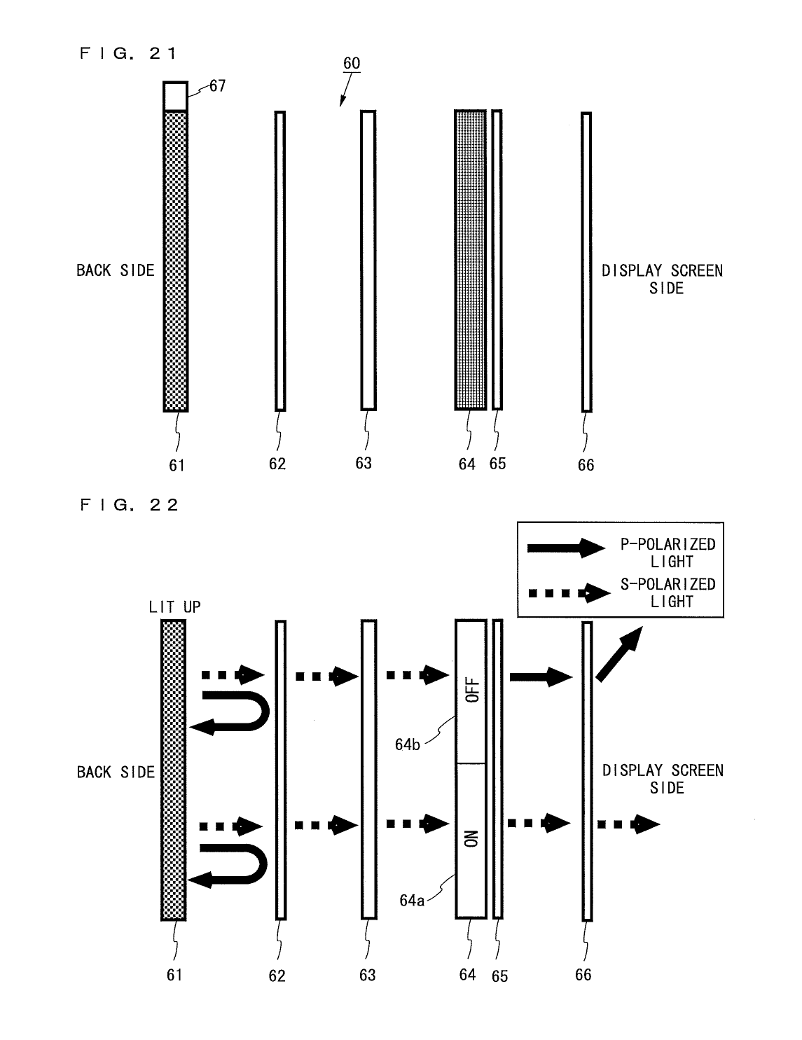

In the first embodiment, the liquid crystal panel 31 of the display 11 is of a normally white type. However, a normally black liquid crystal panel can be used in place of the normally white liquid crystal panel 31. FIG. 20 is a diagram illustrating light absorption and transmission where the display in the first embodiment shown in FIG. 5 uses a normally black liquid crystal panel 33; more specifically, the upper panel of FIG. 20 provides an illustration of light transmission and absorption where pixels of the normally black liquid crystal panel 31 are in on-state, and the lower panel of FIG. 20 provides an illustration of light transmission and absorption where the pixels of the normally black liquid crystal panel 31 are in off-state. Note that as in the case of the normally white liquid crystal panel 31, the on-state pixel refers to the pixel to which a signal voltage corresponding to the image signal DV1 is being applied, and the off-state pixel refers to the pixel to which no signal voltage corresponding to the image signal DV1 is being applied.

First, light transmission and absorption where the pixels of the liquid crystal panel 31 are in on-state will be described with reference to the upper panel of FIG. 20. Unlike in the case shown in FIG. 6, the on-state pixels of the liquid crystal panel 33 allows p-polarized light incident through the second reflective polarizing plate 52 and the first absorptive polarizing plate 41 to pass therethrough after converting the p-polarized light into s-polarized light. The resultant s-polarized light is emitted toward the second absorptive polarizing plate 42. The s-polarized light is transmitted through the second absorptive polarizing plate 42 and reaches the display screen side. Consequently, screen portions that correspond to the on-state pixels are displayed in white.

Next, light transmission and absorption where the pixels of the liquid crystal panel 31 are in off-state will be described with reference to the lower panel of FIG. 20. Unlike in the case shown in FIG. 6, the off-state pixels of the liquid crystal panel 33 allow p-polarized light incident through the second reflective polarizing plate 52 and the first absorptive polarizing plate 41 to pass therethrough without changing the polarization of the light. The p-polarized light having passed through the off-state pixels is absorbed by the second absorptive polarizing plate 42, and therefore, does not reach the display screen side. Thus, screen portions that correspond to the off-state pixels are displayed in black.

In this manner, in the case of the normally black liquid crystal panel 33, the on-state pixels are displayed in white whereas the off-state pixels are displayed in black, so that a monochrome image based on the image signal DV1 is displayed, although the black and white correspondence is opposite to that in the case of the normally white liquid crystal panel 31. Thus, the viewer on the display screen side can visually recognize a monochrome image with its black and white portions being changed around compared to the case shown in FIG. 6. Note that in the case where the display 11 is used as a transparent display, it is also possible to use the normally black liquid crystal panel 33 as in the case shown in FIG. 7.

As can be appreciated from the foregoing, in the case of the normally black liquid crystal panel 31, unlike in the case of the normally white liquid crystal panel 31, the on-state pixels are polarization conversion pixels, and their corresponding screen portions are displayed in white (second display state). On the other hand, the off-state pixels are non-polarization conversion pixels, and their corresponding screen portions are displayed in black (first display state).

### INDUSTRIAL APPLICABILITY

The present invention is applied to a see-through image display device, which allows the background to be seen therethrough.

### DESCRIPTION OF THE REFERENCE CHARACTERS

10, 11, 12, 13, 14 display
20 light guiding plate
25 light source
31 liquid crystal panel (first liquid crystal panel)
32 liquid crystal panel (second liquid crystal panel)
33 liquid crystal panel
41 first absorptive polarizing plate
42 second absorptive polarizing plate
43 third absorptive polarizing plate
51 first reflective polarizing plate
52 second reflective polarizing plate
53 third reflective polarizing plate
DV1 first image signal
DV2 second image signal

1. An image display device comprising a display providing image display based on an image signal or functioning as a transparent display, wherein,
the display includes:
a light source configured to emit light including first polarized light and second polarized light;
a light guiding plate configured to emit light from the light source toward both a display screen side and a back side of the display, the light guiding plate having the light source attached at an end;
a first reflective polarizing plate and a second reflective polarizing plate being arranged with the light guiding plate positioned therebetween, such that the first reflective polarizing plate is disposed on the back side and the second reflective polarizing plate is disposed on the display screen side,
a first liquid crystal panel capable of displaying an image based on an externally provided first image signal, the first liquid crystal panel including a plurality of pixels and being located on the display screen side relative to the second reflective polarizing plate, and
a first absorptive polarizing plate and a second absorptive polarizing plate being arranged with the first liquid crystal panel positioned therebetween, such that the first absorptive polarizing plate is disposed on the back side and the second absorptive polarizing plate is disposed on the display screen side,
the first reflective polarizing plate and the second reflective polarizing plate are first-phase polarizing plates configured to transmit the first polarized light therethrough,
the first absorptive polarizing plate is the first-phase polarizing plate,
the second absorptive polarizing plate is a second-phase polarizing plate configured to transmit the second polarized light therethrough,
when the first image signal is being provided to the first liquid crystal panel, screen portions that correspond to non-polarization conversion pixels of the first liquid crystal panel are in a first display state, and screen portions that correspond to polarization conversion pixels are in a second display state, so that an image based on the first image signal is displayed, and
when the first image signal is not being provided to the first liquid crystal panel, the pixels of the first liquid crystal panel are polarization conversion pixels, so that light incident from the back side reaches the display screen side.

2. (canceled)

3. The image display device according to claim 1, wherein,
the display further includes a third absorptive polarizing plate disposed on the back side relative to the first reflective polarizing plate, and
the third absorptive polarizing plate is the first-phase polarizing plate.

4. The image display device according to claim 1, wherein, when a signal to change the polarization of the first polarized light to predetermined polarization between the first polarized light and the second polarized light is provided, the polarization conversion pixel of the first liquid crystal panel emits light obtained by converting the polarization of the first polarized light into the predetermined polarization.

5. The image display device according to claim 1, wherein the first liquid crystal panel is a normally white liquid crystal panel.

6. The image display device according to claim 1, wherein the first liquid crystal panel has a color filter attached to a surface.

7. The image display device according to claim 1, wherein,
the display further includes:
a second liquid crystal panel capable of displaying an image based on an externally provided second image signal, the second liquid crystal panel including a plurality of pixels and being located on the back side relative to the first reflective polarizing plate; and
a third absorptive polarizing plate and a fourth absorptive polarizing plate being arranged with the second liquid crystal panel positioned therebetween, such that the third absorptive polarizing plate is disposed on the back side relative to the second liquid crystal panel and the fourth absorptive polarizing plate is disposed on the display screen side relative to the second liquid crystal panel,
the third absorptive polarizing plate is the second-phase polarizing plate, and the fourth absorptive polarized plate is the first-phase polarizing plates, and
when the second image signal is being provided to the second liquid crystal panel, screen portions that correspond to non-polarization conversion pixels of the second liquid crystal panel are in the first display state, and screen portions that correspond to polarization conversion pixels are in the second display state, so that an image based on the second image signal is displayed.

8. The image display device according to claim 3, wherein,
the display further includes:
a second liquid crystal panel capable of displaying an image based on an externally provided second image signal, the second liquid crystal panel including a plurality of pixels and being located on the back side relative to the first reflective polarizing plate; and
a third reflective polarizing plate located on the back side relative to the second liquid crystal panel,
the third reflective polarizing plate is the first-phase polarizing plate,
when the second image signal is being provided to the second liquid crystal panel, screen portions that correspond to non-polarization conversion pixels of the second liquid crystal panel are in the second display state, and screen portions that correspond to polarization conversion pixels are in the first display state, so that an image based on the second image signal is displayed, and
when the pixels of the second liquid crystal panel are non-polarization conversion pixels and the pixels of the first liquid crystal panel are polarization conversion pixels, light incident from the back side is transmitted sequentially through the pixels of the second liquid crystal panel and the pixels of the first liquid crystal panel and reaches the display screen side.

9. The image display device according to claim 7, wherein, when a signal to change the polarization of the first polarized light to predetermined polarization between the first polarized light and the second polarized light is provided, the polarization conversion pixel of the second liquid crystal panel emits light obtained by converting the polarization of the first polarized light into the predetermined polarization.

10. The image display device according to claim 7, wherein the second liquid crystal panel is a normally white liquid crystal panel.

11. The image display device according to claim 1, wherein the light source emits light sequentially in a plurality of colors in a time division manner.

12. The image display device according to claim 1, wherein the light guiding plate has a degree of haze adjusted to from 2% to 3%.

13. The image display device according to claim 12, wherein the degree of haze of the light guiding plate is adjusted by incorporating transparent particles about the size of from 20 μm to 300 μm in the light guiding plate at the time of production.
